(19) United States
(12) Patent Application Publication
(10) Pub. No.: US 2026/0341796 A1
(43) Pub. Date: Oct. 29, 2026

(54) SECONDARY BATTERY, BATTERY PACK, AND VEHICLE

(71) Applicant: KABUSHIKI KAISHA TOSHIBA, Kawasaki-shi Kanagawa (JP)

(72) Inventors: Keigo HOSHINA, Yokohama Kanagawa (JP); Keitaro TAKAHASHI, Kawasaki Kanagawa (JP); Kento KANO, Tokyo (JP); Yoshiaki MURATA, Kawasaki Kanagawa (JP); Kakuya UEDA, Kawasaki Kanagawa (JP); Yasunobu YAMASHITA, Tokyo (JP); Yasuhiro HARADA, Isehara Kanagawa (JP); Norio TAKAMI, Yokohama Kanagawa (JP)

(73) Assignee: KABUSHIKI KAISHA TOSHIBA, Kawasaki-shi Kanagawa (JP)

(21) Appl. No.: 19/533,924

(22) Filed: Feb. 9, 2026

(30) Foreign Application Priority Data
Apr. 25, 2025 (JP) 2025-073675

(51) Int. Cl. H01M 10/0583; H01M 4/02; H01M 4/485; H01M 4/583; H01M 4/66; H01M 10/0525

(52) U.S. Cl. CPC H01M 10/0583; H01M 4/485; H01M 4/583; H01M 4/661; H01M 10/0525; H01M 2004/027; H01M 2220/20

(57) ABSTRACT

In general, according to an embodiment, a secondary battery includes negative electrodes and a separator. Each of the negative electrodes includes a negative electrode current collector containing aluminum or an aluminum alloy and a negative electrode tab extending along a first direction. Each of the negative electrodes has a second negative electrode end positioned at an end in a second direction. The separator has a first separator end positioned at an end in the first direction and a second separator end positioned at an end in the second direction. The second separator end protrudes beyond the second negative electrode end. Lnₘᵢₙ denoting a minimum value of Ln which is a distance between the second negative electrode end and the second separator end is 1.5 mm or more. The difference between the Lnₘᵢₙ and Lnₘₐₓ denoting a maximum value of the Ln is 1.0 mm or more.

### CROSS-REFERENCE TO RELATED APPLICATION

This application is based upon and claims the benefit of priority from Japanese Patent Application No. 2025-073675, filed Apr. 25, 2025, the entire contents of which are incorporated herein by reference.

### FIELD

Embodiments described herein relate generally to a secondary battery, a battery pack, and a vehicle.

### BACKGROUND

Since a secondary battery can be repeatedly charged and discharged, the secondary battery is useful for reducing waste, and is widely used as a power supply for a portable device that cannot take an alternating current (AC) power supply, or a backup power supply in case of disconnection or stoppage of the AC power supply. In recent years, the expansion of use of the secondary battery has been studied in vehicle-mounted applications, backup applications of solar cells, power leveling applications, and the like. Accordingly, the demand for performance improvement of the secondary battery such as capacity, high-temperature operation, safety, and the like is increasing more and more.

Among secondary batteries, the nonaqueous electrolyte secondary battery is a secondary battery that performs charge and discharge by movement of lithium ions between positive and negative electrodes. Since the nonaqueous electrolyte secondary battery uses an organic solvent as an electrolytic solution, a voltage higher than that of a nickel-cadmium secondary battery or a nickel-metal hydride secondary battery using an aqueous solution can be obtained. For example, the currently commercialized nonaqueous electrolyte secondary battery uses a transition metal oxide such as a lithium-cobalt composite oxide or a lithium-nickel composite oxide as a positive electrode active material. As the negative electrode active material, for example, a carbon-based material, an oxide containing titanium, or the like is used. As the electrolytic solution, for example, a liquid nonaqueous electrolyte obtained by dissolving a lithium salt such as LiPF₆ or LiBF₄ in an organic solvent such as a cyclic carbonate or a chain carbonate is used. The positive electrode active material has an average operating potential of about 3.4 V to 3.8 V (vs. Li/Li⁺) based on lithium metal, and a maximum achieved potential of about 4.1 V to 4.3 V (vs. Li/Li⁺) during charge. On the other hand, the operating potential range of the carbon-based material of the negative electrode active material is about 0.05 V to 0.5 V (vs. Li/Li⁺) based on lithium metal. The operating potential range of lithium titanate (Li₄Ti₅O₁₂), which is a typical compound as a titanium-containing composite oxide as a negative electrode active material, is 1.55 V (vs. Li/Li⁺). By combining these positive and negative electrode materials, the battery voltage is 2.2 V to 3.8 V, and the maximum charge voltage is 2.7 V to 4.3 V.

A secondary battery using a titanium-containing composite oxide for a negative electrode can improve a charge-discharge cycle life, output performance, and safety, and has been put to practical use. Various titanium-containing composite oxides have been proposed, but there are many reports of spinel type lithium titanate (for example, Li₄Ti₅O₁₂, TLO for short), which has already been used in commercial products. In Li₄Ti₅O₁₂, which is an example of the spinel type lithium titanate, the minimum potential reached during charge is 1.0 V to 1.45 V (vs. Li/Li⁺) based on lithium metal, and the maximum potential reached during discharge is 1.6 V to 2.0 V (vs. Li/Li⁺). On the other hand, there are monoclinic titanium dioxide (TiO₂, commonly known as TiO₂(B)), niobium titanium composite oxides (for example, monoclinic Nb₂TiO₇ and orthorhombic niobium titanium composite oxide), and the like, and they provide a larger capacity than that of spinel type lithium titanate. In the monoclinic titanium dioxide, the minimum potential reached during charge is 0.9 V to 1.45 V (vs. Li/Li⁺) based on lithium metal, and the maximum potential reached during discharge is 1.6 V to 2.5 V (vs. Li/Li⁺). In the monoclinic Nb₂TiO₇, which is an example of the niobium-titanium composite oxide, the minimum potential reached during charge is 0.6 V to 1.40 V (vs. Li/Li⁺) based on lithium metal, and the maximum potential reached during discharge is 1.8 V to 3.0 V (vs. Li/Li⁺).

If the positive electrode and the negative electrode having such a configuration are brought into electrical contact with each other, a short circuit will occur. Therefore, in order to prevent contact between the positive and negative electrodes, a sheet-shaped separator made of a material having an electrical insulation property can be used, for example.

### BRIEF DESCRIPTION OF DRAWINGS

FIG. 1 is a schematic partially cutaway perspective view of an example of a secondary battery according to an embodiment.

FIG. 2 is an enlarged cross-sectional view of a part B of the secondary battery illustrated in FIG. 1.

FIG. 3 is a plan view of a negative electrode included in the secondary battery illustrated in FIG. 1.

FIG. 4 is a plan view of a positive electrode included in the secondary battery illustrated in FIG. 1.

FIG. 5 is an enlarged view of FIG. 2.

FIG. 6 is an enlarged view of a portion of an electrode group illustrated in FIG. 2 different from that of FIG. 5.

FIG. 7 is a perspective view of another example of the electrode group.

FIG. 8 is a schematic perspective view of an example of a battery module according to the embodiment.

FIG. 9 is a schematic exploded perspective view of an example of a battery pack according to the embodiment.

FIG. 10 is a block diagram illustrating an example of an electric circuit of the battery pack illustrated in FIG. 8.

FIG. 11 is a partially transparent diagram schematically illustrating an example of a vehicle according to the embodiment.

FIG. 12 is a diagram schematically illustrating an example of a control system related to an electrical system in a vehicle according to the embodiment.

### DETAILED DESCRIPTION

According to an embodiment, a secondary battery is provided. The secondary battery includes positive electrodes, negative electrodes, and a separator interposed between the positive electrodes and the negative electrodes. Each of the negative electrodes includes a negative electrode current collector, a negative electrode tab, and a negative electrode active material-containing layer provided at the negative electrode current collector. The negative electrode current collector contains aluminum or an aluminum alloy. The negative electrode tab is electrically connected to the negative electrode current collector and extends along a first direction. Each of the negative electrodes has a second negative electrode end positioned at an end in a second direction opposite to the first direction. The separator has a first separator end positioned at an end in the first direction and a second separator end positioned at an end in the second direction. The second separator end protrudes in the second direction beyond the second negative electrode end of the negative electrodes. Lnₘᵢₙ is 1.5 mm or more. The difference between the Lnₘᵢₙ and Lnₘₐₓ is 1.0 mm or more. The Lnₘᵢₙ denotes a minimum value of Ln which is a distance between the second negative electrode end and the second separator end. The Lnₘₐₓ denotes a maximum value of the Ln.

As an electrode stack, positive electrodes and negative electrodes alternately stacked with one or more separators interposed therebetween may be used. Each separator is arranged such that an end of the separator is positioned outside an end of the positive electrode and an end of the negative electrode in order to suppress a short circuit between the positive electrode and the negative electrode.

However, in such an electrode stack, if all the ends of the negative electrodes are arranged so as to be aligned in the thickness direction, a strong force is likely to be applied to the separator in contact with the end of the negative electrode. For example, in the manufacture of the electrode stack, the positive electrodes, the negative electrodes, and the separators may be stacked and then pressed in the thickness direction. In such a case, since the end of each negative electrode is pressed against a part of the separator from both sides along the thickness direction, a strong force is likely to be locally applied to the separator. As a result, a short circuit is likely to occur.

### First Embodiment

According to a first embodiment, a secondary battery is provided. The secondary battery includes positive electrodes, negative electrodes, and a separator interposed between the positive electrodes and the negative electrodes. Each of the negative electrodes includes a negative electrode current collector, a negative electrode tab, and a negative electrode active material-containing layer provided at the negative electrode current collector. The negative electrode current collector contains aluminum or an aluminum alloy. The negative electrode tab is electrically connected to the negative electrode current collector and extends along a first direction. Each of the negative electrode has a second negative electrode end positioned at an end in a second direction opposite to the first direction. The separator has a first separator end positioned at an end in the first direction and a second separator end positioned at an end in the second direction. The second separator end protrudes in the second direction beyond the second negative electrode end of the negative electrodes. Lnₘᵢₙ is 1.5 mm or more. The difference between the Lnₘᵢₙ and Lnₘₐₓ is 1.0 mm or more. The Lnₘᵢₙ denotes a minimum value of Ln which is a distance between the second negative electrode end and the second separator end. The Lnₘₐₓ denotes a maximum value of the Ln.

The negative electrode current collector containing aluminum or an aluminum alloy has high flexibility and is easy to process.

The second separator end protrudes in the second direction beyond the second negative electrode end of the negative electrodes. In other words, the second separator end may protrude in the second direction beyond all the second negative electrode ends of the plurality of negative electrodes. Therefore, a short circuit between the negative electrode and the positive electrode can be suppressed.

Of the distances Ln between the second negative electrode ends of the negative electrodes and the second separator end, the smallest value Lnₘᵢₙ is 1.5 mm or more. In other words, the second negative electrode ends of the plurality of negative electrodes are separated from the second separator end by 1.5 mm or more. Therefore, even if the negative electrode is positionally displaced in the second direction due to an external force, for example, it is possible to prevent the negative electrode from protruding outward beyond the second separator end. This suppresses a short circuit, thereby improving charge-discharge cycle performance.

Of the distances Ln between the second negative electrode ends of the negative electrodes and the second separator end, the largest value Lnₘₐₓ has a difference of 1.0 mm or more from Lnₘᵢₙ. That is, the second negative electrode ends of the negative electrodes are not aligned along the thickness direction. This makes it possible to suppress breakage of the separator that could be caused by locally applying a strong force to the separator. As a result, short circuit is less likely to occur, so that charge-discharge cycle performance can be improved.

The secondary battery according to the embodiment will be further described with reference to the drawings as appropriate.

The secondary battery according to the first embodiment includes negative electrodes, positive electrodes, and a separator. The negative electrodes, the positive electrodes, and the separator can constitute an electrode group. The secondary battery can further include an electrolyte. The electrolyte can be held in the electrode group.

The secondary battery may further include a container member that stores the electrode group and the electrolyte.

Moreover, the secondary battery may further include a negative electrode terminal electrically connected to the negative electrode and a positive electrode terminal electrically connected to the positive electrode.

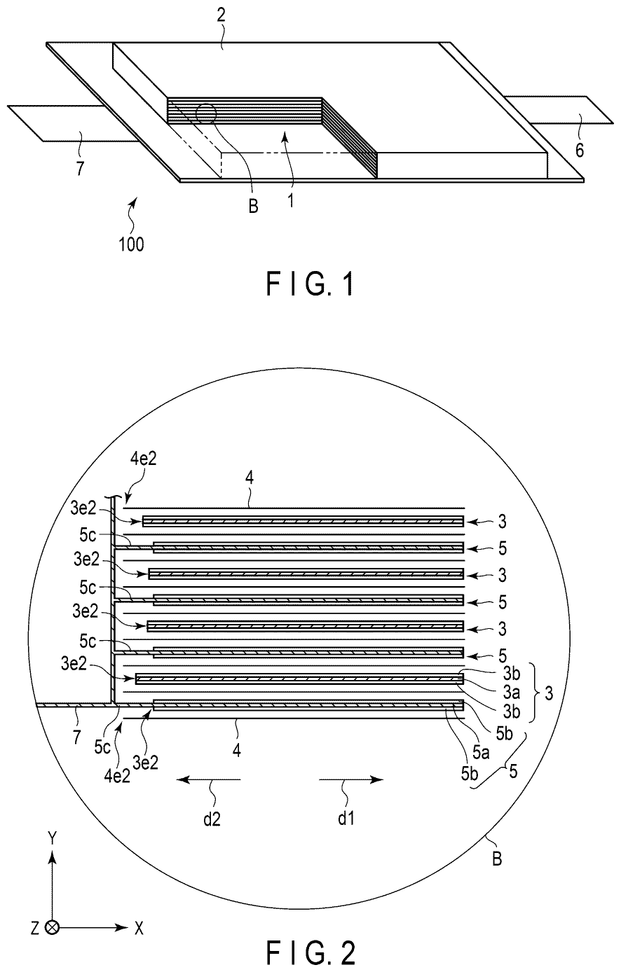

FIG. 1 is a schematic partially cutaway perspective view of an example of the secondary battery. FIG. 2 is an enlarged cross-sectional view of a part B of the secondary battery illustrated in FIG. 1.

A secondary battery 100 illustrated in FIGS. 1 and 2 includes an electrode group 1 illustrated in FIGS. 1 and 2, a container member 2 illustrated in FIG. 1, and an electrolyte (not illustrated). The electrode group 1 and the electrolyte are stored in the container member 2. The electrolyte is held in the electrode group 1.

The container member 2 is formed of a laminate film including two resin layers and a metal layer interposed therebetween.

As illustrated in FIG. 2, the electrode group 1 is a stacked electrode group. The stacked electrode group 1 has a structure in which a negative electrode 3 and a positive electrode 5 are alternately stacked with a separator 4 interposed therebetween.

In FIGS. 2 to 6 referred to below, the Y axis is an axis along the stacking direction of the negative electrodes, the positive electrodes, and the separators. The X axis is an axis orthogonal to the Y axis. The Z axis is an axis orthogonal to both the X axis and the Y axis. A first direction d1 and a second direction d2 are directions along the X axis.

The electrode group 1 includes negative electrodes 3. Each of the negative electrodes 3 includes a negative electrode current collector 3a and a negative electrode active material-containing layer 3b supported on both surfaces of the negative electrode current collector 3a. The electrode group 1 includes positive electrodes 5. Each of the positive electrodes 5 includes a positive electrode current collector 5a and a positive electrode active material-containing layer 5b supported on both surfaces of the positive electrode current collector 5a.

The positive electrode current collector 5a of each positive electrode 5 includes, on one edge thereof, a portion where the positive electrode active material-containing layer 5b is not supported on any surface. In the secondary battery illustrated in FIG. 1, this portion serves as a positive electrode tab 5c. The positive electrode tab 5c is electrically connected to the positive electrode current collector 5a. The plurality of positive electrode tabs 5c are electrically connected to the belt-shaped positive electrode terminal 7. The leading end of the belt-shaped positive electrode terminal 7 is drawn out of the container member 2.

Although not illustrated, the negative electrode current collector 3a of each negative electrode 3 includes, on one edge thereof, a portion where the negative electrode active material-containing layer 3b is not supported on any surface. In the secondary battery illustrated in FIG. 1, this portion serves as a negative electrode tab 3c. The negative electrode tab 3c is electrically connected to the negative electrode current collector 3a. The negative electrode tab may not overlap with the positive electrode 5. The negative electrode tab is positioned on the opposite side of the electrode group 1 with respect to the positive electrode tab 5c. The negative electrode tabs are electrically connected to the belt-shaped negative electrode terminal 6. The leading end of the belt-shaped negative electrode terminal 6 is positioned on the side opposite to the positive electrode terminal 7 and is drawn out of the container member 2.

The negative electrode 3 has a second negative electrode end 3e2 positioned at an end in the second direction d2. The separator 4 has a second separator end 4e2 positioned at an end in the second direction d2. The second separator end 4e2 protrudes in the second direction d2 beyond all the second negative electrode ends 3e2.

In the example illustrated in FIG. 2, the second negative electrode ends 3e2 of the negative electrodes 3 do not overlap along the Y-axis direction. That is, the plurality of second negative electrode ends 3e2 are not aligned along the stacking direction. In the secondary battery including such an electrode group, it is possible to suppress application of a locally strong force to the separators as compared with an electrode group in which second negative electrode ends are aligned along the stacking direction. This makes a short circuit less likely to occur. Although FIG. 2 illustrates an example in which all the second negative electrode ends are located at different positions along the stacking direction, the form in which the plurality of second negative electrode ends are not aligned along the stacking direction is not limited to this. For example, the second negative electrode end of at least one of the negative electrodes may be present at a different position from the other second negative electrode ends along the stacking direction. It is preferable that at least half of the negative electrodes be in a state of not overlapping each other along the stacking direction.

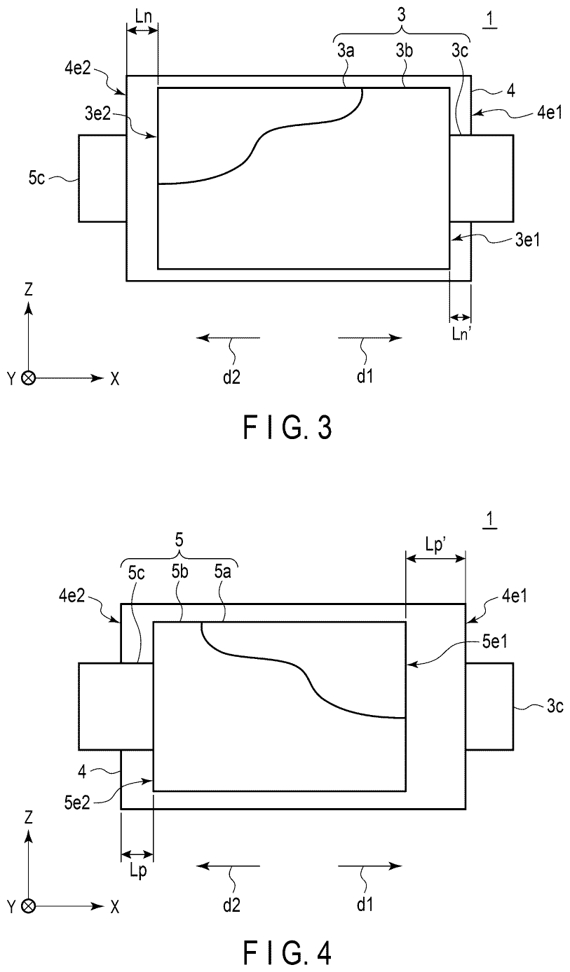

FIG. 3 is a plan view of a negative electrode included in the secondary battery illustrated in FIG. 1. FIG. 3 illustrates a state in which the negative electrode current collector 3a is exposed by cutting out a part of the negative electrode active material-containing layer 3b for the sake of explanation. However, in the negative electrode illustrated in FIG. 3, the negative electrode active material-containing layer 3b is provided on the entire surface of the negative electrode current collector 3a along the X axis and the Z axis. That is, in the electrode illustrated in FIG. 3, the surfaces of the negative electrode active material-containing layer 3b and the negative electrode current collector 3a along the X axis and the Z axis have the same rectangular shape.

The negative electrode tab 3c of the negative electrode 3 extends along the first direction d1. The negative electrode 3 has the second negative electrode end 3e2 positioned at an end in the second direction d2 opposite to the first direction d1. The separator 4 has a first separator end 4e1 positioned at an end in the first direction d1 and a second separator end 4e2 positioned at an end in the second direction d2.

The second separator end 4e2 protrudes in the second direction d2 beyond the second negative electrode end 3e2. The distance between the second negative electrode end 3e2 and the second separator end 4e2 is indicated by reference sign Ln.

The first separator end 4e1 protrudes in the first direction d1 beyond the first negative electrode end 3e1. The distance between the first negative electrode end 3e1 and the first separator end 4e1 is indicated by reference sign Ln′.

FIG. 4 is a plan view of a positive electrode included in the secondary battery illustrated in FIG. 1. FIG. 4 illustrates a state in which the positive electrode current collector 5a is exposed by cutting out a part of the positive electrode active material-containing layer 5b for the sake of explanation. However, in the positive electrode illustrated in FIG. 4, the positive electrode active material-containing layer 5b is provided on the entire surface of the positive electrode current collector 5a along the X axis and the Z axis. That is, in the positive electrode illustrated in FIG. 4, the surfaces of the positive electrode active material-containing layer 5b and the positive electrode current collector 5a along the X axis and the Z axis have the same rectangular shape.

The positive electrode tab 5c of the positive electrode 5 extends along the second direction d2. The positive electrode 5 has a first positive electrode end 5e1 positioned at an end in the first direction d1 and a second positive electrode end 5e2 positioned at an end in the second direction d2.

The second separator end 4e2 protrudes in the second direction d2 beyond the second positive electrode end 5e2. The distance between the second positive electrode end 5e2 and the second separator end 4e2 is indicated by reference sign Lp.

The first separator end 4e1 protrudes in the first direction d1 beyond the first positive electrode end 5e1. The distance between the first positive electrode end 5e1 and the first separator end 4e1 is indicated by reference sign Lp′.

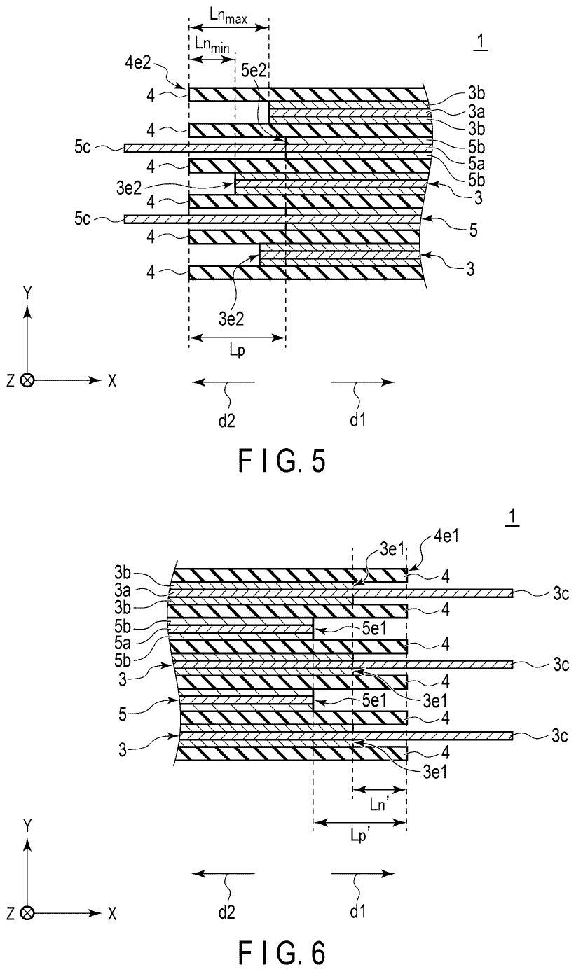

In the electrode group described with reference to FIGS. 1 and 2, a portion including the negative electrodes having the maximum Ln and the negative electrodes having the minimum Ln is enlarged and illustrated in FIGS. 5 and 6. FIG. 5 is a diagram illustrating the portion in the vicinity of the positive electrode terminal (positive electrode tab side). FIG. 6 is a diagram illustrating the portion in the vicinity of the negative electrode terminal (negative electrode tab side).

Each of the three negative electrodes 3 illustrated in FIG. 5 has the second negative electrode end 3e2. The second separator end 4e2 protrudes in the second direction d2 beyond all the second negative electrode ends 3e2.

In the example illustrated in FIG. 5, the second separator ends 4e2 of the plurality of separators 4 included in the electrode group are aligned along the stacking direction (Y-axis direction). In this manner, if the electrode group includes the plurality of separators 4, it can be said that all the second separator ends 4e2 of the plurality of separators protrude in the second direction d2 beyond all the second negative electrode ends 3e2 of the negative electrodes 3.

Of the distances Ln between the second negative electrode end 3e2 and the second separator end 4e2 for each of the plurality of negative electrodes 3, the smallest distance Ln (minimum value of Ln) is denoted by reference sign Lnₘᵢₙ. Among the distances Ln, the largest distance (maximum value) is indicated as Lnₘₐₓ.

If the distance Lnₘᵢₙ is 1.5 mm or more, it can be said that, in the electrode group 1, the second negative electrode end of the negative electrode where the second negative electrode end 3e2 protrudes most along the second direction is separated from the second separator end 4e2 by 1.5 mm or more. Therefore, even if the negative electrode is displaced when an external force is applied to the electrode group, for example, it is possible to suppress the occurrence of a short circuit. In addition, since the difference between the distance Lnₘᵢₙ and the distance Lnₘₐₓ is 1.0 mm or more, it is possible to suppress application of a strong force to the separator. Therefore, it is possible to suppress the occurrence of a short circuit between the negative electrode and the positive electrode tab due to the negative electrode penetrating the separator, for example.

From the viewpoint of securing the battery capacity, the difference between the distance Lnₘᵢₙ and the distance Lnₘₐₓ is preferably 2.5 mm or less, for example. The difference between Lnₘᵢₙ and Lnₘₐₓ is preferably 1.2 mm or more, more preferably 1.5 mm or more. The maximum value of the difference between Lnₘᵢₙ and Lnₘₐₓ can be set to 2.0 mm, for example, and is more preferably set to 1.8 mm.

The value of Lnₘᵢₙ may be 1.5 mm or more, preferably 2.0 mm or more, and more preferably 2.5 mm or more. The maximum value of Lnₘᵢₙ may be 4.0 mm. Lnₘᵢₙ is preferably 3.5 mm or less, more preferably 3.0 mm or less. Lnₘᵢₙ can be set to 1.5 mm or more and 3.5 mm or less, for example.

Lnₘₐₓ can be set to 2.5 mm or more and 4.5 mm or less, for example. Although FIGS. 2 and 5 illustrate the electrode group having three or more types of Ln, two types of Ln may be used. Specifically, the negative electrodes included in the electrode group may include one or more negative electrodes having a large value of the two types of Ln and one or more negative electrodes having the other value (small value) of the two types of Ln. If two types of Ln are used, the larger Ln can be set as Lnₘₐₓ, and the smaller Ln can be set as Lnₘᵢₙ.

Each of the three negative electrodes 3 illustrated in FIG. 6 has the negative electrode tab 3c extending along the first direction d1.

In the example illustrated in FIG. 6, the first positive electrode ends 5e1 of the plurality of positive electrodes 5 included in the electrode group are aligned along the stacking direction (Y-axis direction). The first negative electrode ends 3e1 of the negative electrodes 3 are aligned along the stacking direction. The first negative electrode end 3e1 of the negative electrodes protrude in the first direction d1 beyond the first positive electrode end 5e1 of the positive electrodes. In the example illustrated in FIG. 6, all the first negative electrode ends 3e1 protrude in the first direction d1 beyond all the first positive electrode ends 5e1 of the plurality of positive electrodes 5.

Reference is now made again to FIG. 5. The second negative electrode end 3e2 of the negative electrodes protrude in the second direction d2 beyond the second positive electrode end 5e2 of the positive electrodes. In the example illustrated in FIG. 5, all the second negative electrode ends 3e2 of the negative electrodes 3 protrude toward the second direction d2 beyond all the second positive electrode ends 5e2 of the plurality of positive electrodes 5.

Of the distances Lp between the second positive electrode ends 5e2 of the plurality of positive electrodes 5 and the second separator ends 4e2, the smallest value (minimum value) is Lpₘᵢₙ, and the (maximum value) is Lpₘₐₓ. As illustrated in FIG. 5, the second positive electrode ends 5e2 of the plurality of positive electrodes 5 included in the electrode group 1 are aligned along the stacking direction. Therefore, it can be said that the distance Lp illustrated in FIG. 5 is Lpₘᵢₙ and Lpₘₐₓ.

If the difference between the distance Lpₘᵢₙ and the distance Lnₘᵢₙ is 1.5 mm or more, it can be said that the second positive electrode end of the positive electrode where the second positive electrode end 5e2 protrudes most along the second direction d2 is separated by 1.5 mm or more from the second negative electrode end of the negative electrode where the second negative electrode end 3e2 protrudes most along the second direction d2. Therefore, even if the negative electrode or the positive electrode is displaced when an external force is applied to the electrode group, for example, it is possible to suppress the protrusion of the second positive electrode end beyond the second negative electrode end. As a result, deposition of metal due to concentration of current on the negative electrode can be suppressed, so that a short circuit is less likely to occur. Further, in this electrode group, since the difference between the distance Lnₘᵢₙ and the distance Lnₘₐₓ is 1.0 mm or more, damage to the separator due to application of a strong force to the separator can be suppressed, so that occurrence of a short circuit can be further suppressed.

From the viewpoint of balancing the positive electrode capacity and the negative electrode capacity, the difference between the distance Lpₘᵢₙ and the distance Lnₘᵢₙ is preferably 5.0 mm or less, for example. Lpₘᵢₙ can be set to 3.5 mm or more and 6.5 mm or less, for example.

With reference to FIG. 6 again, the negative electrode tab side of the electrode group will be described.

As illustrated in FIG. 6, all the first negative electrode ends 3e1 protrude in the first direction beyond all the first positive electrode ends 5e1. Therefore, even if the negative electrode or the positive electrode is displaced when an external force is applied to the electrode group, for example, it is possible to suppress the protrusion of the first positive electrode end beyond the first negative electrode end. Therefore, it is possible to suppress the occurrence of a short circuit due to concentration of current on the negative electrode.

Further, all the first separator ends 4e1 protrude in the first direction beyond all the first negative electrode ends. Therefore, the occurrence of a short circuit can be suppressed.

Of the distances Ln′ between the first negative electrode ends 3e1 of the negative electrodes 3 and the first separator ends 4e1, the smallest value is Ln′ₘᵢₙ, and the largest value is Ln′ₘₐₓ. In the example illustrated in FIG. 6, the first negative electrode ends 3e1 of the negative electrodes 3 included in the electrode group 1 are aligned along the stacking direction. Therefore, it can be said that the distance Ln illustrated in FIG. 6 is Ln′ₘᵢₙ and Ln′ₘₐₓ.

Of the distances Lp′ between the first positive electrode ends 5e1 of the plurality of positive electrodes 5 and the first separator ends 4e1, the smallest value is Lp′ₘᵢₙ, and the largest value is Lp′ₘₐₓ. In the example illustrated in FIG. 6, the first positive electrode ends 5e1 of the plurality of positive electrodes 5 included in the electrode group 1 are aligned along the stacking direction. Therefore, it can be said that the distance Lp′ illustrated in FIG. 6 is Lp′ₘᵢₙ and Lp′ₘₐₓ.

If the difference between the minimum value and the maximum value of distances between the first negative electrode ends of the negative electrodes and the first separator ends is 0.6 mm or less, it can be said that “the first negative electrode ends are aligned along the stacking direction”. The same applies to the first positive electrode ends. Further, if the difference between the minimum value and the maximum value of distances between the second negative electrode ends of the negative electrodes and the second separator ends is 0.6 mm or less, it can be said that “the second negative electrode ends are aligned along the stacking direction”. The same applies to the second positive electrode ends.

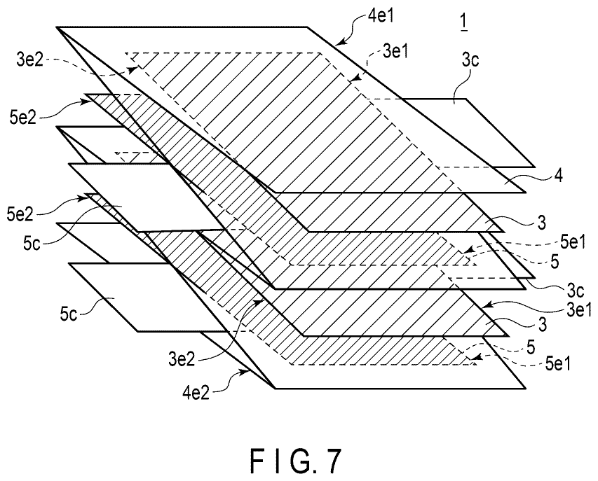

In the battery illustrated in FIG. 1, an electrode group illustrated in FIG. 7 may be used instead of the electrode group described above. The electrode group 1 illustrated in FIG. 7 is configured by folding the separator 4 in a zigzag and alternately arranging negative electrodes 3 and positive electrodes 5 at the folded portions. Specifically, the negative electrode 3, the positive electrode 5, the negative electrode 3, and the positive electrode 5 are arranged in this order so as to be sandwiched in the separator 4 folded in a zigzag. Negative electrode tabs 3c protrude from one long edge portion of the separator 4 folded in a zigzag. Positive electrode tabs 5c protrude from the other long edge portion of the separator 4 folded in a zigzag.

The order of the negative electrodes 3 and the positive electrodes 5 is not limited to the order illustrated in FIG. 7. The positive electrode 5, the negative electrode 3, the positive electrode 5, and the negative electrode 3 may be arranged in this order.

The numbers of the positive electrodes and the negative electrodes included in the electrode group are not particularly limited, and can be changed as appropriate according to a desired capacity, a battery size, and the like, but for example, the numbers of the positive electrodes and the negative electrodes can be each 40 or more and 70 or less. The number of separators is not particularly limited, and can be changed as appropriate depending on the shape of the separators. For example, a plurality of sheet-shaped separators may be used, and one separator may be interposed between the positive electrode and the negative electrode, or one separator may be folded, and pluralities of negative electrodes and positive electrodes may be alternately arranged at folded portions.

Such a secondary battery may be a secondary battery using an alkali metal ion as a charge carrier (carrier ion), for example. Specifically, the secondary battery may be a lithium ion secondary battery using lithium (Li) as a carrier ion or a sodium secondary battery using sodium (Na) as a carrier ion. The secondary battery includes a nonaqueous electrolyte secondary battery containing a nonaqueous electrolyte.

Hereinafter, the negative electrode, the positive electrode, the electrolyte, the separator, the container member, the negative electrode terminal, and the positive electrode terminal that can be included in the secondary battery according to the embodiment will be described in detail.

### 1) Negative Electrode

The negative electrode includes a negative electrode current collector, a negative electrode active material-containing layer, and a negative electrode tab.

The negative electrode active material-containing layer can be formed on one side or both sides of the negative electrode current collector. The negative electrode active material-containing layer can contain a negative electrode active material, and optionally an electro-conductive agent and a binder.

Examples of the negative electrode active material include metals, nonmetals, alloys, oxides, sulfides, phosphides, acid sulfides, phosphoric acid compounds, sulfuric acid compounds, and carbon materials. The kind of the negative electrode active material can be one kind or two or more kinds.

Examples of the metal include lithium metal.

Examples of the non-metal include silicon.

Examples of the oxide include lithium titanate having a ramsdellite structure (for example, Li_{2+y}Ti₃O₇, 0≤y≤3), lithium titanate having a spinel structure (for example, Li₄₊ₓTi₅O₁₂, 0≤x≤3), titanium dioxide (TiO₂), anatase titanium dioxide, rutile titanium dioxide, niobium pentoxide (Nb₂O₅), hollandite titanium composite oxide, orthorhombic titanium composite oxide, niobium-containing oxide, and monoclinic niobium titanium-containing oxide. The negative electrode containing these negative electrode active materials can be used, for example, as a negative electrode of a lithium ion secondary battery.

Examples of the orthorhombic titanium-containing composite oxide include a compound represented by Li₂₊ₐM^{I}_{2-b}Ti_{6-c}M^{II}_{d}O_{14+σ}. Here, M^{I} is at least one selected from the group consisting of Sr, Ba, Ca, Mg, Na, Cs, Rb, and K. M^{II} is at least one selected from the group consisting of Zr, Sn, V, Nb, Ta, Mo, W, Y, Fe, Co, Cr, Mn, Ni, and Al. The respective subscripts in the composition formulae satisfy 0≤a≤6, 0≤b<2, 0≤c<6, 0≤d<6, and −0.5≤σ≤0.5. Specific examples of the orthorhombic titanium-containing composite oxide include Li₂₊ₐNa₂Ti₆O₁₄ (0≤a≤6).

Examples of the niobium-containing oxide include Nb₁₆W₅O₅₅, Nb₁₈W₁₆O₉₃, and Nb₁₄W₃O₄₄.

Examples of the monoclinic niobium titanium-containing oxide include a compound represented by LiₓTi_{1-y}M1_{y}Nb_{2-z}M2_{z}O_{7+δ}. Here, M1 is at least one selected from the group consisting of Zr, Si, and Sn. M2 is at least one selected from the group consisting of V, Ta, and Bi. The respective subscripts in the composition formulae satisfy 0≤x≤5, 0≤y<1, 0≤z<2, and −0.3≤δ≤0.3. Specific examples of the monoclinic niobium titanium-containing oxide include LiₓNb₂TiO₇ (0≤x≤5).

Other examples of the monoclinic niobium titanium-containing oxide include a compound represented by LiₓTi_{1-y}M3_{y+z}Nb_{2-z}O_{7-δ}. Here, M3 is at least one selected from Mg, Fe, Ni, Co, W, Ta, and Mo. The respective subscripts in the composition formulae satisfy 0≤x≤5, 0≤y<1, 0≤z<2, and −0.3≤δ≤0.3.

Examples of the negative electrode active material include carbon materials such as hard carbon and graphite, alloys containing tin (Sn), oxides, and sulfides. The negative electrode containing these negative electrode active materials can be used, for example, as a negative electrode of a sodium secondary battery. Also in the negative electrode of the sodium secondary battery, the kind of the negative electrode active material can be one kind or two or more kinds.

Examples of the oxide include compounds represented by Fe₂O₃, TiO₂, and Li/NaₓTi_{1-y}Nb_{y}O₂, in which x and y satisfy 0≤x≤1 and 0<y≤0.2, respectively.

Examples of the sulfide include FeS, CoS, and MoS₂.

The electro-conductive agent is blended in order to enhance current collection performance and to suppress contact resistance between the negative electrode active material and the negative electrode current collector. Examples of the electro-conductive agent include vapor grown carbon fiber (VGCF), carbon black such as acetylene black, and carbonaceous substances such as graphite, carbon nanotubes, and carbon nanofibers. One of them may be used as an electro-conductive agent, or two or more of them may be used in combination as an electro-conductive agent. Alternatively, instead of using the electro-conductive agent, carbon coating or electron conductive inorganic material coating may be applied to the surface of the negative electrode active material particle.

The binder is blended to fill gaps between the dispersed negative electrode active materials and to bind the negative electrode active material and the negative electrode current collector. Examples of the binder include polytetrafluoro ethylene (PTFE), polyvinylidene fluoride (PVdF), fluororubber, styrene-butadiene rubber, polyacrylic acid compound, imide compound, carboxymethyl cellulose (CMC), and salts of CMC. One of them may be used as a binder, or two or more of them may be used in combination as a binder.

The blending ratio of the negative electrode active material, the electro-conductive agent, and the binder in the negative electrode active material-containing layer can be changed as appropriate. For example, the negative electrode active material, the electro-conductive agent, and the binder are preferably blended in proportions of 68 mass % or more and 97 mass % or less, 2 mass % or more and 30 mass % or less, and 1 mass % or more and 30 mass % or less, respectively. Setting the amount of the electro-conductive agent to 2 mass % or more can improve the current collection performance of the negative electrode active material-containing layer. Setting the amount of the binder to 2 mass % or more ensures sufficient property of binding between the negative electrode active material-containing layer and the negative electrode current collector, and excellent cycle performance can be expected. On the other hand, each of the amounts of the electro-conductive agent and the amounts of the binder are preferably set to 30 mass % or less to increase the capacity.

The negative electrode current collector contains aluminum or an aluminum alloy. As the aluminum alloy, for example, an alloy containing aluminum and one or more elements selected from Mg, Ti, Zn, Mn, Fe, Cu, and Si can be used.

The negative electrode current collector containing aluminum or an aluminum alloy can be electrochemically stable at a potential at which a charge carrier is inserted into and extracted from the negative electrode active material.

For example, in a lithium ion secondary battery, aluminum and an aluminum alloy can be electrochemically stable at a potential at which lithium (Li) as a charge carrier is inserted and extracted. In a sodium secondary battery, aluminum and an aluminum alloy can be electrochemically stable at a potential at which sodium (Na) as a charge carrier is inserted and extracted.

The thickness of the negative electrode current collector is preferably 7 μm or more and 20 μm or less. The negative electrode current collector having such a thickness can balance the strength and weight reduction of the negative electrode.

In addition, the negative electrode current collector may include a portion where the negative electrode active material-containing layer is not formed on the surface thereof. This portion can act as a negative electrode tab. A negative electrode tab separate from the negative electrode current collector may be joined to the negative electrode current collector by welding or the like. In any case, it can be said that the negative electrode tab is electrically connected to the negative electrode current collector.

The density of the negative electrode active material-containing layer (not including the current collector) is preferably 1.8 g/cm³ or more and 2.8 g/cm³ or less. The negative electrode in which the density of the negative electrode active material-containing layer is within this range is excellent in energy density and electrolyte retention. The density of the negative electrode active material-containing layer is more preferably 2.1 g/cm³ or more and 2.6 g/cm³ or less.

The size of the negative electrode is not particularly limited, and can be changed according to a desired capacity. For example, the distance from the first negative electrode end to the second negative electrode end can be set to 15 cm or more and 100 cm or less. Within this range, it is possible to easily obtain the effect of suppressing a short circuit due to the fact that Lnₘᵢₙ is 1.5 mm or more and the difference between Lnₘᵢₙ and Lnₘₐₓ is 1.0 mm or more. The distance from the first negative electrode end to the second negative electrode end may be, for example, 150.0 mm or more and 1000.0 mm or less, or may be 190.0 mm or more and 210.0 mm or less.

The distance from the first negative electrode end to the second negative electrode end can be a length along the first direction of the negative electrode active material-containing layer. The width of the negative electrode active material-containing layer orthogonal to the first direction is not particularly limited, but may be 50.0 mm or more and 500.0 mm or less, or may be 90.0 mm or more and 110.0 mm or less.

The negative electrode can be produced, for example, by the following method. First, a negative electrode active material, an electro-conductive agent, and a binder are suspended in a solvent to prepare a slurry. The slurry is applied to one side or both sides of the negative electrode current collector. Next, the applied slurry is dried to obtain a stack of the negative electrode active material-containing layer and the negative electrode current collector. Thereafter, the stack is pressed. In this way, a negative electrode is produced.

Alternatively, the negative electrode may be produced by the following method. First, a negative electrode active material, an electro-conductive agent, and a binder are mixed to obtain a mixture. Then, the mixture is formed into pellets. Next, by arranging these pellets on the negative electrode current collector, a negative electrode can be obtained.

### 2) Positive Electrode

The positive electrode may include a positive electrode current collector, a positive electrode active material-containing layer, and a positive electrode tab. The positive electrode active material-containing layer may be formed on one side or both sides of the positive electrode current collector. The positive electrode active material-containing layer can contain a positive electrode active material, and optionally an electro-conductive agent and a binder.

Examples of the positive electrode active material include a compound capable of inserting and extracting Li or Li ions, and a compound capable of inserting and extracting Na or Na ions. The compound capable of inserting and extracting Li or Li ions may be an oxide or a sulfide capable of inserting and extracting Li or Li ions, for example.

The positive electrode may contain one kind of compound alone or two or more kinds of compounds in combination as the positive electrode active material.

A positive electrode containing a compound capable of inserting and extracting Li or Li ions as a positive electrode active material can be used, for example, as a positive electrode of a lithium ion secondary battery.

Examples of the compound capable of inserting and extracting Li or Li ions include manganese dioxide (MnO₂), iron oxide, copper oxide, nickel oxide, lithium manganese composite oxide (for example, LiₓMn₂O₄ or LiₓMnO₂, 0<x≤1), lithium nickel composite oxide (for example, LiₓNiO₂; 0<x≤1), lithium-cobalt composite oxide (for example, LiₓCoO₂; 0<x≤1), lithium nickel cobalt composite oxide (for example, LiₓNi_{1-y}Co_{y}O₂; 0<x≤1, 0<y<1), lithium manganese cobalt composite oxide (for example, LiₓMn_{y}Co_{1-y} O₂; 0<x≤1, 0<y<1), lithium manganese nickel composite oxide having a spinel structure (for example, LiₓMn_{2-y}Ni_{y}O₄; 0<x≤1, 0<y≤2), lithium phosphorus oxide having an olivine structure (for example, LiₓFePO₄; 0<x≤1, LiₓFe_{1-y}Mn_{y}PO₄; 0<x≤1, 0<y≤1, LiₓCoPO₄; 0<x≤1), iron sulfate (Fe₂(SO₄)₃), vanadium oxide (for example, V₂O₅), and lithium nickel cobalt manganese composite oxide (LiₓNi_{1-y-z}Co_{y}Mn_{z}O₂; 0<x≤1, 0<y<1, 0<z<1, y+z<1).

Among the above, examples of the compound more preferable as the positive electrode active material include a lithium-manganese composite oxide having a spinel structure (for example, LiₓMn₂O₄; 0<x≤1), lithium nickel composite oxide (for example, LiₓNiO₂; 0<x≤1), lithium-cobalt composite oxide (for example, LiₓCoO₂; 0<x≤1), lithium nickel cobalt composite oxide (for example, LiₓNi_{1-y}Co_{y}O₂; 0<x≤1, 0<y<1), lithium manganese nickel composite oxide having a spinel structure (for example, LiₓMn_{2-y}Ni_{y}O₄; 0<x≤1, 0<y<2), lithium manganese cobalt composite oxide (for example, LiₓMn_{y}Co_{1-y}O₂; 0<x≤1, 0<y<1), lithium iron phosphate (for example, LiₓFePO₄; 0<x≤1), and lithium-nickel-cobalt-manganese composite oxide (LiₓNi_{1-y-z}Co_{y}Mn_{z}O₂; 0<x≤1, 0<y<1, 0<z<1, y+z<1). Using these compounds for the positive electrode active material increases the positive electrode potential.

In a case of using a room temperature molten salt as the electrolyte of the battery, it is preferable to use a positive electrode active material containing lithium iron phosphate, LiₓVPO₄F (0≤x<1), lithium manganese composite oxide, lithium nickel composite oxide, lithium nickel cobalt composite oxide, or a mixture thereof. Since these compounds have low reactivity with room temperature molten salts, the cycle life can be improved. Details of the room temperature molten salt will be described later.

The positive electrode containing a compound capable of inserting and extracting Na or Na ions as a positive electrode active material can be used, for example, as a positive electrode of a sodium secondary battery.

Examples of the compound capable of inserting and extracting Na or Na ions include sodium transition metal oxides, sodium transition metal phosphate compounds, and Prussian blue analogues. In addition to the above, examples include Na₄Ti₅O₁₂, Na₂NiMn₃O₈, Na₂S, FeS, TiS₂, NaFeO₂, NaMn₂O₄, and Na₂TiS₃.

Examples of the sodium transition metal oxide include a compound represented by NaₙM^{I}ₓM^{II}_{y}M^{III}_{z}O₂. Here, each of M^{I}, M^{II}, and M^{III} is at least one selected from the group consisting of Ni, Co, Mn, Fe, Cu, Al, V, Cr, Zn, Ti, and Mg. Each subscript in the composition formula satisfies 0<n≤1.2, 0≤x≤1, 0≤y≤1, 0≤z≤1, and x+y+z=1. Examples of the compound represented by NaₙM^{I}ₓM^{II}_{y}M^{III}_{z}O₂ include NaFe_{0.33}Ni_{0.33}Mn_{0.33}O₂.

Examples of the sodium transition metal phosphate compound include a compound represented by Na₃M₂(PO₄)₃ or NaₐFe_{b}(PO₄)_{c}P₂O₇. Here, M is at least one selected from the group consisting of Ni, Co, Mn, V, and Cr. Each subscript in the composition formula satisfies 3≤a≤4; a=c+2; b=c+1, 1≤c≤2.

Examples of the Prussian blue analogues may include a compound represented by NaₙM^{I}ₓ[M^{II} (CN)₆]_{y}·zH₂O. Here, M^{I} and M^{II} are at least one selected from the group consisting of Fe, Co, Ni, Cu, Zn, Ti, V, Cr, and Mn. Each subscript in the composition formula satisfies 1<n≤2, 0<x≤1, and 0<y≤1. In addition, z satisfies 0<z≤16.

The positive electrode active material may preferably have primary particle sizes in the range of 100 nm to 1 μm. The positive electrode active material having primary particle sizes of 100 nm or more may be easy to handle in industrial applications. The positive electrode active material having primary particle sizes of 1 μm or less may allow lithium ions to be smoothly diffused in solid.

The positive electrode active material may preferably have a specific surface area in the range of 0.1 m²/g to 10 m²/g. The positive electrode active material having a specific surface area of 0.1 m²/g or more may secure an adequately large site for insertion and extraction of Li ions. The positive electrode active material having a specific surface area of 10 m²/g or less may be easy to handle in industrial applications and may ensure a favorable charge-and-discharge cycle.

The binder is blended in order to fill a gap between the dispersed positive electrode active materials and to bind the positive electrode active material and the positive electrode current collector. Examples of the binder include polytetrafluoroethylene (PTFE), polyvinylidene fluoride (PVdF), fluorine rubber, polyacrylic acid compounds, imide compounds, carboxy methyl cellulose (CMC), and salts of CMC. One of these may be used as the binder, or a combination of two or more thereof may be used as the binder.

A conductive agent is added in order to increase the current-collecting performance and suppress the contact resistance between the positive electrode active material and the positive electrode current collector. Examples of the conductive agent include carbonaceous materials such as vapor grown carbon fibers (VGCF), carbon black such as acetylene black, graphite, carbon nanofibers and carbon nanotubes. One of these materials may be used as the conductive agent, or two or more of these materials may be combined and used as the conductive agent. In addition, the conductive agent can be omitted.

In the positive electrode active material-containing layer, it is preferable to combine the positive electrode active material and the binder in a mass ratio of the positive electrode active material in a range from 80% to 98% and the binder in a range from 1% to 20%.

By making the amount of the binder be 1% by mass or greater, sufficient electrode strength is obtained. In addition, the binder may function as an insulator. For this reason, if the amount of the binder is kept at 20% by mass or less, the amount of insulation contained in the electrode is decreased, and therefore the internal resistance can be reduced.

In the case of adding the conductive agent, it is preferable to combine the positive electrode active material, the binder, and the conductive agent in a mass ratio of the positive electrode active material in a range from 77% to 96%, the binder in a range from 1% to 20%, and conductive agent in a range from 3% to 15%.

By making the amount of the conductive agent be 3% by mass or greater, the effects described above can be exhibited. Also, by keeping the amount of the conductive agent to 15% by mass or less, the proportion of the conductive agent in contact with electrolyte can be lowered. If this proportion is low, decomposition of the electrolyte under high-temperature storage can be reduced.

The positive electrode current collector is preferably an aluminum foil or an aluminum alloy foil containing one or more elements selected from Mg, Ti, Zn, Ni, Cr, Mn, Fe, Cu, and Si.

The thickness of the aluminum foil or aluminum alloy foil is preferably within a range from 5 μm to 20 μm, and is more preferably 15 μm or less. The purity of the aluminum foil is preferably 99% by mass or more. The content of transition metals such as iron, copper, nickel, and chromium contained in the aluminum foil or aluminum alloy foil is preferably 1% by mass or less.

In addition, the positive electrode current collector can include a portion where the positive electrode active material-containing layer is not formed on the surface thereof. This portion can act as a positive electrode tab. A positive electrode tab separate from the positive electrode current collector may be joined to the positive electrode current collector by welding or the like. In any case, it can be said that the positive electrode tab is electrically connected to the positive electrode current collector.

The size of the positive electrode is not particularly limited, and can be changed according to a desired capacity. For example, the distance from the first positive electrode end to the second positive electrode end can be set to 15 cm or more and 100 cm or less. Furthermore, the distance from the first positive electrode end to the second positive electrode end is preferably shorter than the distance from the first negative electrode end to the second negative electrode end by 2.0 mm or more and 10.0 mm or less. Within this range, the occurrence of a short circuit can be effectively suppressed. The distance from the first positive electrode end to the second positive electrode end may be, for example, 140.0 mm or more and 1000.0 mm or less, or may be 180.0 mm or more and 210.0 mm or less.

The distance from the first positive electrode end to the second positive electrode end may be a length along the first direction of the positive electrode active material-containing layer. The width of the positive electrode active material-containing layer orthogonal to the first direction is not particularly limited, but may be 50.0 mm or more and 500.0 mm or less, or may be 85.0 mm or more and 110.0 mm or less.

The positive electrode can be produced, for example, by the following method. First, a positive electrode active material, an electro-conductive agent, and a binder are suspended in a solvent to prepare a slurry. The slurry is applied to one side or both sides of the positive electrode current collector. Next, the applied slurry is dried to obtain a stack of the positive electrode active material-containing layer and the positive electrode current collector. Thereafter, the stack is pressed. In this way, a positive electrode is produced.

Alternatively, the positive electrode may be produced by the following method. First, a positive electrode active material, an electro-conductive agent, and a binder are mixed to obtain a mixture. Then, the mixture is formed into pellets. Next, by arranging these pellets on the positive electrode current collector, a positive electrode can be obtained.

### 3) Electrolyte

As the electrolyte, for example, a nonaqueous electrolyte can be used.

As the nonaqueous electrolyte, for example, a liquid nonaqueous electrolyte or a gel nonaqueous electrolyte can be used. The liquid nonaqueous electrolyte is prepared by dissolving an electrolyte salt as a solute in an organic solvent. The concentration of the electrolyte salt is preferably 0.5 mol/L or more and 2.5 mol/L or less.

Examples of the electrolyte salt include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and lithium bistrifluoromethylsulfonylimide [LiN(CF₃SO₂)₂], and mixtures thereof. The electrolyte salt is preferably resistant to oxidation even at a high potential, and most preferably LiPF₆.

Examples of the organic solvent include cyclic carbonates such as propylene carbonate (PC), ethylene carbonate (EC), or vinylene carbonate (VC); linear carbonates such as diethyl carbonate (DEC), dimethyl carbonate (DMC), or methyl ethyl carbonate (MEC); cyclic ethers such as tetrahydrofuran (THF), 2-methyl tetrahydrofuran (2-MeTHF), or dioxolane (DOX); linear ethers such as dimethoxy ethane (DME) or diethoxy ethane (DEE); γ-butyrolactone (GBL), acetonitrile (AN), and sulfolane (SL). These organic solvents may be used singularly or as a mixed solvent.

The gel nonaqueous electrolyte is prepared by obtaining a composite of a liquid nonaqueous electrolyte and a polymeric material. Examples of the polymeric material include polyvinylidene fluoride (PVDF), polyacrylonitrile (PAN), polyethylene oxide (PEO), and mixtures thereof.

Alternatively, besides the nonaqueous liquid electrolyte and the nonaqueous gel electrolyte, a room-temperature molten salt (normal temperature molten salt, ionic melt) containing lithium ions, a polymer solid electrolyte, an inorganic solid electrolyte, and the like may also be used as the nonaqueous electrolyte.

The room temperature molten salt indicates compounds among organic salts made of combinations of organic cations and anions, which are able to exist in a liquid state at room temperature (15 °C to 25 °C). The room temperature molten salt includes a room temperature molten salt which exists alone as a liquid, a room temperature molten salt which becomes a liquid upon mixing with an electrolyte salt, a room temperature molten salt which becomes a liquid when dissolved in an organic solvent, and mixtures thereof. In general, the melting point of the room temperature molten salt used in secondary batteries is 25 °C or below. The organic cations generally have a quaternary ammonium framework.

A polymer solid electrolyte is prepared by dissolving an electrolyte salt into a polymer material and solidifying the result.

The inorganic solid electrolyte is a solid substance having Li ion conductivity. Having Li ion conductivity, as referred to herein, indicates exhibiting a lithium ion conductivity of 1×10⁻⁶ S/cm or more at 25 °C. Examples of the inorganic solid electrolyte include oxide solid electrolytes and sulfide solid electrolytes. Specific examples of the inorganic solid electrolyte are described below.

Preferably used as the oxide solid electrolyte is a lithium phosphate solid electrolyte having a NASICON (Sodium (Na) Super Ionic Conductor) structure represented by a general formula Li₁₊ₓMα₂(PO₄)₃. Ma in the above general formula is, for example, one or more selected from the group consisting of titanium (Ti), germanium (Ge), strontium (Sr), zirconium (Zr), tin (Sn), aluminum (Al), and calcium (Ca). The subscript x is within the range of 0≤x≤2.

Specific examples of the lithium phosphate solid electrolyte having the NASICON structure include a LATP compound represented by Li₁₊ₓAlₓTi₂₋ₓ(PO₄)₃ where 0.1≤x≤0.5; a compound represented by Li₁₊ₓAl_{y}Mβ_{2-y} (PO₄)₃ where Mβ is one or more selected from the group consisting of Ti, Ge, Sr, Zr, Sn, and Ca, 0≤x≤1, and 0≤y≤1; a compound represented by Li₁₊ₓAlₓGe₂₋ₓ(PO₄)₃ where 0≤x≤2; a compound represented by Li₁₊ₓAlₓZr₂₋ₓ(PO₄)₃ where 0≤x≤2; a compound represented by Li_{1+x+y}AlₓMγ₂₋ₓSi_{y}P_{3-y}O₁₂ where Mγ is one or more selected from the group consisting of Ti and Ge, 0<x≤2, and 0≤y<3; and a compound represented by Li₁₊₂ₓZr₁₋ₓCaₓ(PO₄)₃ where 0≤x<1.

In addition to the above lithium phosphate solid electrolyte, examples of the oxide solid electrolyte include amorphous LIPON compounds represented by LiₓPO_{y}N_{z} where 2.6≤x≤3.5, 1.9≤y≤3.8, and 0.1≤z≤1.3 (e.g., Li_{2.9}PO_{3.3}N_{0.46}); a compound having a garnet structure represented by La₅₊ₓAₓLa₃₋ₓMδ₂O₁₂ where A is one or more selected from the group consisting of Ca, Sr, and Ba, Mδ is one or more selected from the group consisting of Nb and Ta, and 0≤x≤0.5; a compound represented by Li₃Mδ₂₋ₓL₂O₁₂ where Mδ is one or more selected from the group consisting of Nb and Ta, L may include Zr, and 0≤x≤0.5; a compound represented by Li₇₋₃ₓAlₓLa₃Zr₃O₁₂ where 0≤x≤0.5; a LLZ compound represented by Li₅₊ₓLa₃Mδ₂₋ₓZrₓO₁₂ where Mδ is one or more selected from the group consisting of Nb and Ta, and 0≤x≤2 (e.g., Li₇La₃Zr₂O₁₂); and a compound having a perovskite structure and represented by La_{2/3-x}LiₓTiO₃ where 0.3≤x≤0.7.

One or more among the above compounds may be used as the solid electrolyte. Two or more of the above solid electrolytes may be used, as well.

The electrolyte described above can be applied as, for example, an electrolyte of a lithium ion secondary battery. As the material of the electrolyte, a material obtained by replacing lithium (Li) with sodium (Na) among the materials of the electrolyte described above may be used. The electrolyte containing such a material can be applied as, for example, an electrolyte of a sodium secondary battery.

### 4) Separator

The separator includes a porous film containing polyethylene (PE), polypropylene (PP), cellulose, or polyvinylidene fluoride (PVdF), or a synthetic resin nonwoven fabric, for example. From the viewpoint of safety, the separator preferably includes a porous film formed of polyethylene or polypropylene. This is because these porous films can melt at a certain temperature to block the current.

As the separator, the above-described porous film or synthetic resin nonwoven fabric may be used alone, but in addition to the above-described porous film or synthetic resin nonwoven fabric, a solid electrolyte membrane or a ceramic membrane may be used in combination, for example. For example, as the separator, a solid electrolyte membrane or a ceramic membrane can be stacked on at least one surface of the porous sheet. Any one of the solid electrolyte membrane and the ceramic membrane may be used, or both may be used in combination.

The separator is preferably a composite solid electrolyte membrane including a solid electrolyte membrane on at least one surface of a porous film or a synthetic resin nonwoven fabric. Examples of the composite solid electrolyte membrane include a coated separator in which a solid electrolyte layer is formed by applying a dispersion containing solid electrolyte particles to at least one surface of a porous film or a synthetic resin nonwoven fabric.

The solid electrolyte membrane includes solid electrolyte particles. The solid electrolyte membrane may include, for example, solid electrolyte particles and a polymer material, and the solid electrolyte particles may be formed into a membrane using the polymer material. The solid electrolyte membrane may be formed of only solid electrolyte particles. The solid electrolyte membrane may contain one type of solid electrolyte particles, or may contain a plurality of types of solid electrolyte particles. The solid electrolyte membrane may contain at least one selected from the group consisting of a plasticizer and an electrolyte salt. When the solid electrolyte membrane contains an electrolyte salt, for example, alkali metal ion conductivity of the solid electrolyte membrane can be further enhanced.

As the solid electrolyte, the same solid electrolyte as described above can be used.

The polymer material may be, for example, granular or fibrous. Examples of the polymer material include a polyether-based polymer, a polyester-based polymer, a polyamine-based polymer, a polyethylene-based polymer, a silicone-based polymer, and a polysulfide-based polymer.

The ceramic film may or may not have lithium ion conductivity. The lithium ion conductivity of the ceramic film is, for example, less than 2×10⁻¹⁴ S/cm at 25 °C. Examples of the material constituting the ceramic film include zinc oxide (For example, ZnO or ZnO₂), alumina (for example, Al₂O₃), boehmite, zirconia (for example, ZrO₂), boron oxide (for example, B₂O₃), and titanium oxide (for example, TiO or TiO₂). The ceramic film may contain a polymer material similarly to the solid electrolyte membrane. The ceramic film may further contain solid electrolyte particles in addition to the ceramic described above.

### 5) Container Member

As the container member, for example, a container made of laminate film or a container made of metal may be used.

The thickness of the laminate film is, for example, 0.5 mm or less, and preferably 0.2 mm or less.

As the laminate film, used is a multilayer film including multiple resin layers and a metal layer sandwiched between the resin layers. The resin layer may include, for example, a polymeric material such as polypropylene (PP), polyethylene (PE), nylon, or polyethylene terephthalate (PET). The metal layer is preferably made of aluminum foil or an aluminum alloy foil, so as to reduce weight. The laminate film may be formed into the shape of a container member, by heat-sealing.

The wall thickness of the metal container is, for example, 1 mm or less, more preferably 0.5 mm or less, and still more preferably 0.2 mm or less.

The metal case is made, for example, of aluminum or an aluminum alloy. The aluminum alloy preferably contains elements such as magnesium, zinc, or silicon. If the aluminum alloy contains a transition metal such as iron, copper, nickel, or chromium, the content thereof is preferably 100 ppm by mass or less.

The shape of the container member is not particularly limited. The shape of the container member may be, for example, flat (thin), square, cylinder, coin, or button-shaped. The container member may be appropriately selected depending on battery size and use of the battery.

### 6) Negative Electrode Terminal

The negative electrode terminal may be made of a material that is electrochemically stable at the potential at which Li is inserted into and extracted from the above-described negative electrode active material, and has electrical conductivity. Specific examples of the material for the negative electrode terminal include copper, nickel, stainless steel, aluminum, and aluminum alloy containing at least one element selected from the group consisting of Mg, Ti, Zn, Mn, Fe, Cu, and Si. Aluminum or aluminum alloy is preferred as the material for the negative electrode terminal.

If the negative electrode terminal is connected to the negative electrode tab, the negative electrode terminal is preferably made of the same material as the negative electrode tab in order to reduce contact resistance. The negative electrode terminal may be made of the same material as the negative electrode current collector.

The negative electrode terminal described above can be applied as, for example, a negative electrode terminal of a lithium ion secondary battery. It can also be applied as a negative electrode terminal of a sodium secondary battery. This is because the materials described above are electrochemically stable even at a Na insertion and extraction potential of the negative electrode active material that can be used for a sodium battery.

### 7) Positive Electrode Terminal

The positive electrode terminal can be formed of a material that is electrically stable in a potential range of 3 V or more and 4.5 V or less with respect to the oxidation-reduction potential of lithium (vs. Li/Li⁺) and has conductivity. Examples of the material for the positive electrode terminal include aluminum, or an aluminum alloy containing at least one element selected from the group consisting of Mg, Ti, Zn, Mn, Fe, Cu, and Si. If the positive electrode terminal is connected to the positive electrode tab, the positive electrode terminal is preferably made of the same material as the positive electrode tab in order to reduce contact resistance. The positive electrode terminal may be made of the same material as the positive electrode current collector.

The positive electrode terminal described above can be applied as, for example, a positive electrode terminal of a lithium ion secondary battery. It can also be applied as a positive electrode terminal of a sodium secondary battery. This is because the materials described above are electrochemically stable even at a Na insertion and extraction potential of the positive electrode active material that can be used for a sodium battery.

### (Manufacturing Method)

The secondary battery according to the embodiment can be produced, for example, by the following method. First, positive electrodes and negative electrodes are produced by the method described above, and then the negative electrode and/or the positive electrodes are adjusted to a desired size. At this time, the sizes of the negative electrodes are not made uniform. The specific method will be described below.

First, in the negative electrode, a direction in which the negative electrode tab is drawn out with respect to the negative electrode current collector is defined as a first direction, and the opposite direction is defined as a second direction.

An end of the negative electrode active material-containing layer in the first direction is defined as a first negative electrode end, and an end of the negative electrode in the second direction is defined as a second negative electrode end.

The sizes of the negative electrodes are adjusted such that the distance (length) from the first negative electrode end to the second negative electrode end has different values. More specifically, the sizes are adjusted such that all the lengths of the negative electrodes do not have the same value.

The difference between the length of the negative electrode having the shortest length and the length of the negative electrode having the longest length among the negative electrodes can be 1.0 mm or more, for example.

Next, the positive electrodes and the separator are each adjusted to a desired size.

For example, a direction in which the positive electrode tab is drawn out with respect to the positive electrode current collector is defined as a second direction, an opposite direction thereof is defined as a first direction, an end of the positive electrodes in the second direction of the positive electrode active material-containing layer is defined as a second positive electrode end, and an end of the positive electrodes in the first direction is defined as a first positive electrode end. At this time, the distance (length) from the first positive electrode end to the second positive electrode end can be adjusted to be smaller than all the lengths of the negative electrodes. In addition, if there are a plurality of positive electrodes, the sizes of the positive electrodes can be all the same. More specifically, the sizes of the plurality of positive electrodes can be adjusted such that all distances (lengths) from the first positive electrode end to the second positive electrode end have the same value.

In the separator, an end positioned at an end in the first direction is defined as a first separator end, an end positioned at an end in the second direction is defined as a second separator end, and the distance (length) from the first separator end to the second separator end is adjusted so as to be longer than all the lengths of the negative electrodes and the positive electrodes. If there are a plurality of separators, for example, the sizes of the separators can be all the same.

Subsequently, the negative electrodes and the positive electrodes are alternately stacked with a separator interposed therebetween. At this time, the negative electrode tab and the positive electrode tab are stacked so as to extend in directions opposite to each other. That is, the positive electrode tabs are stacked so as to extend in the second direction.

The negative electrodes are stacked such that the respective first negative electrode ends overlap each other along the stacking direction. The positive electrodes are stacked such that the respective second positive electrode ends overlap each other along the stacking direction.

In the separator, an end positioned at an end in the first direction is defined as a first separator end, and an end positioned at an end in the second direction is defined as a second separator end. Stacking is performed such that the second separator end protrudes in the second direction beyond the second negative electrode ends of the negative electrodes. Further, the distance between the second negative electrode end of the longest negative electrode among the negative electrodes and the second separator end is set to 1.5 mm or more.

In this manner, an electrode group is produced.

A terminal may be connected to each of the negative electrode tab and the positive electrode tab by ultrasonic welding or the like. Thereafter, the electrode group is stored in a container member, and an electrolyte is injected into the container member, whereby the electrolyte can be held in the electrode group. Thereafter, a battery can be produced by sealing the opening of the container member. The produced battery may be the secondary battery according to the embodiment, but it is preferable that the battery having been subjected to initial charge and discharge is the secondary battery according to the embodiment. The initial charge and discharge can be done, for example, by performing charging at a constant current and constant voltage (CCCV) and then performing constant current discharge. The initial charge and discharge may cause the electrode group to expand and contract slightly. Specifically, the negative electrodes included in the electrode group may expand during charging. In addition, the negative electrodes may contract during discharge to approach the size before charge. As a result, the negative electrodes after the initial charge and discharge may be slightly expanded.

Therefore, the sizes of the members of the electrode group can be different before and after the initial charge and discharge. In the secondary battery after the initial charge and discharge, it is preferable that Lnₘᵢₙ is 1.5 mm or more, and the difference between Lnₘᵢₙ and Lnₘₐₓ is 1.0 mm or more.

It is preferable to restrain the secondary battery in the initial charge and discharge. The form of the restraint is not particularly limited, but for example, the restraint can be performed by sandwiching the secondary battery between a pair of plate members. The pressure at the time of restraint can be, for example, 0.05 MPa or more and 0.20 MPa or less. Within this range, it is possible to suppress a large change in the dimension of each member of the electrode group from the dimension at the time of assembly. Therefore, even after the initial charge and discharge, it is easy to obtain a secondary battery having Lnₘᵢₙ of 1.5 mm or more and a difference between Lnₘᵢₙ and Lnₘₐₓ of 1.0 mm or more. For example, the surface pressure on the secondary battery sandwiched between the pair of plate members can be set to 0.05 MPa or more and 0.2 MPa or less. The pressure at the time of restraint can be, for example, 0.1 MPa.

### (Measurement Method)

(Method of Measuring Distance between Electrode End and Separator End)

First, the battery to be measured is brought into a discharged state. Thereafter, the container member is opened such that the stacked structure of the electrode group in the container member does not become deformed or the positive electrode, the negative electrode, and the separator do not become damaged. Thereafter, the electrode group in the container member is taken out.

For example, if the container member is made of a laminate sheet, the container member is opened to take out the electrode group. If necessary, a portion where the negative electrode tab and the negative electrode terminal are connected and a portion where the positive electrode tab and the positive electrode terminal are connected are cut.

The separator of the outermost layer of the taken-out electrode group is removed by, for example, turning over to expose the electrode (for example, the negative electrode). For the exposed electrode, a distance from an end of the electrode to an end of the separator is measured. After the measurement, the measured electrode and separator are removed to expose the electrode under the removed electrode and separator, and the measurement is further performed. The measurement is repeated for all the electrodes included in the electrode group.

For example, if the electrode group is formed such that the positive electrode and the negative electrode are alternately stacked with the zigzagged separator interposed therebetween, the measurement is performed while the electrodes are alternately exposed by unfolding the zigzagged separator. If the electrode group is formed such that bag-shaped separators storing electrodes are stacked, the electrodes can be exposed by cutting and opening the bags of the separators.

For example, in the case of measuring the negative electrode, a direction in which the negative electrode tab extends with respect to the negative electrode current collector is defined as a first direction, and a direction opposite to the first direction is defined as a second direction.

An end of the negative electrode positioned at an end in the second direction is defined as a second negative electrode end. In the negative electrode active material-containing layer, an end positioned at an end in the first direction is defined as a first negative electrode end. In the separator, an end positioned at an end in the first direction is defined as a first separator end, and an end positioned at an end in the second direction is defined as a second separator end.

The distance Ln between the second negative electrode end and the second separator end is measured using a ruler. Further, the distance Ln′ between the first negative electrode end and the first separator end is measured.

In the case of measuring the positive electrode, an end of the positive electrode positioned at an end in the first direction is defined as a first positive electrode end. In the positive electrode active material-containing layer, an end positioned at an end in the second direction is defined as a second positive electrode end.

The distance Lp between the first positive electrode end and the first separator end is measured. Further, the distance Lp′ between the second positive electrode end and the second separator end is measured.

The measurement is performed at a position where the distance to the end of the electrode to be measured is the shortest when the ruler is placed with the separator end to be measured as a start point and perpendicular to the separator end.

### (Method for Identifying Composition of Current Collector)

In measuring the composition of the current collector, first, an electrode (for example, a negative electrode) to be measured is taken out from the battery disassembled as described above. The electrode is immersed in water, and then the active material-containing layer and the current collector are separated. The separation can be performed by, for example, ultrasonic treatment or heat treatment such as firing in the atmosphere at 400 °C for two hours.

The current collector separated by the above method can be identified by fluorescent X-ray analysis. For example, the measurement element is identified using the fundamental parameter method (FP method).

### (Composition Analysis of Active Material)

The composition of the active material contained in the active material-containing layer can be identified as described below.

First, the active material-containing layer is separated from the electrode to be measured by the above-described method.

The separated active material-containing layer is subjected to X-ray diffraction measurement. The crystal phase in the active material-containing layer can be measured, and quantitative analysis can be performed by the reference intensity ratio (RIR) method or the like. If the active material is an amorphous phase and a crystal phase is hardly observed by X-ray diffraction, the composition of the active material can be identified by performing composition analysis by fluorescent X-ray analysis and ICP emission spectroscopy together.

### (Method for Measuring Thickness of Current Collector)

The thickness of the current collector included in the electrode can be measured as described below.

First, the active material-containing layer of the electrode to be measured is removed by the method described above, dissolution, or the like. The current collector from which the active material-containing layer has been removed is measured with a thickness meter. The average of thicknesses randomly measured at five locations with a size of 5 cm square is set as the thickness of the current collector.

The secondary battery according to the first embodiment includes positive electrodes, negative electrodes, and a separator interposed between the positive electrodes and the negative electrodes. Each of the negative electrodes includes a negative electrode current collector, a negative electrode tab, and a negative electrode active material-containing layer provided at the negative electrode current collector. The negative electrode current collector contains aluminum or an aluminum alloy. The negative electrode tab is electrically connected to the negative electrode current collector and extends along a first direction. Each of the negative electrode has a second negative electrode end positioned at an end in a second direction opposite to the first direction. The separator has a first separator end positioned at an end in the first direction and a second separator end positioned at an end in the second direction. The second separator end protrudes in the second direction beyond the second negative electrode end of the negative electrodes. Lnₘᵢₙ is 1.5 mm or more. The difference between the Lnₘᵢₙ and Lnₘₐₓ is 1.0 mm or more. The Lnₘᵢₙ denotes a minimum value of Ln which is a distance between the second negative electrode end and the second separator end. The Lnₘₐₓ denotes a maximum value of the Ln. Therefore, the secondary battery can improve charge-discharge cycle performance.

### Second Embodiment

According to the second embodiment, a battery module is provided. The battery module according to the second embodiment is equipped with a plurality of the secondary batteries according to the second embodiment.

In the battery module according to the embodiment, individual unit cells may be electrically connected in series or in parallel, or may be arranged in combination of series connection and parallel connection.

Next, an example of the battery module according to the embodiment will be described with reference to the drawings.

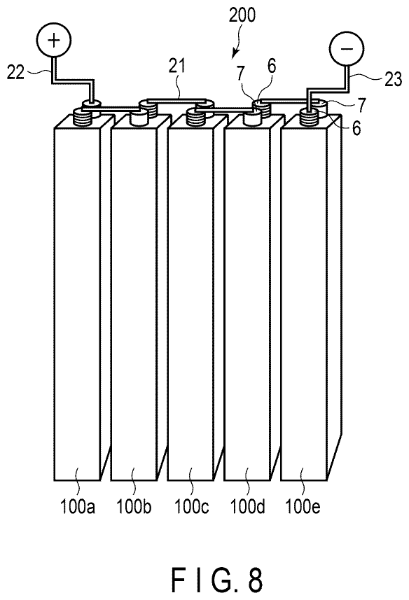

FIG. 8 is a perspective view schematically showing an example of the battery module according to the embodiment. The battery module 200 shown in FIG. 8 includes five unit cells 100a to 100e, four bus bars 21, a positive electrode-side lead 22, and a negative electrode-side lead 23. Each of the five unit cells 100a to 100e is the secondary battery according to the first embodiment.

The busbar 21 connects a negative electrode terminal 6 of a single unit cell 100a to a positive electrode terminal 7 of an adjacently positioned unit cell 100b. In this way, the five unit cells 100a to 100e are connected in series by the four bus bars 21. That is, the battery module 200 shown in FIG. 8 is a battery module of five in-series connection. Although an example is not illustrated, in a battery module containing a plurality of unit cells electrically connected in parallel, the plurality of unit cells may be electrically connected by connecting the plurality of negative electrode terminals to each other with busbars and also connecting the plurality of positive electrode terminals to each other with busbars, for example.

The positive electrode terminal 7 of at least one battery among the five unit cells 100a to 100e is electrically connected to a positive electrode lead 22 for external connection. Also, the negative electrode terminal 6 of at least one battery among the five unit cells 100a to 100e is electrically connected to a negative electrode lead 23 for external connection.

A battery module according to a second embodiment includes the secondary battery according to the first embodiment. Therefore, the charge and discharge cycle can be improved.

### Third Embodiment

According to the third embodiment, a battery pack is provided. The battery pack includes the battery module according to the second embodiment. The battery pack may also be equipped with a single secondary battery according to the first embodiment instead of the battery module according to the second embodiment.

The battery pack according to the embodiment may further include a protective circuit. The protective circuit has a function to control charging and discharging of the secondary battery. Alternatively, a circuit included in equipment where the battery pack serves as a power source (for example, electronic devices, vehicles, and the like) may be used as the protective circuit for the battery pack.

Moreover, the battery pack according to the embodiment may further include an external power distribution terminal. The external power distribution terminal is configured to externally output current from the secondary battery, and to input external current into the secondary battery. In other words, when the battery pack is used as a power source, the current is provided out via the external power distribution terminal. When the battery pack is charged, the charging current (including regenerative energy of a motive force of vehicles such as automobiles) is provided to the battery pack via the external power distribution terminal.

Next, an example of a battery pack according to the embodiment will be described with reference to the drawings.

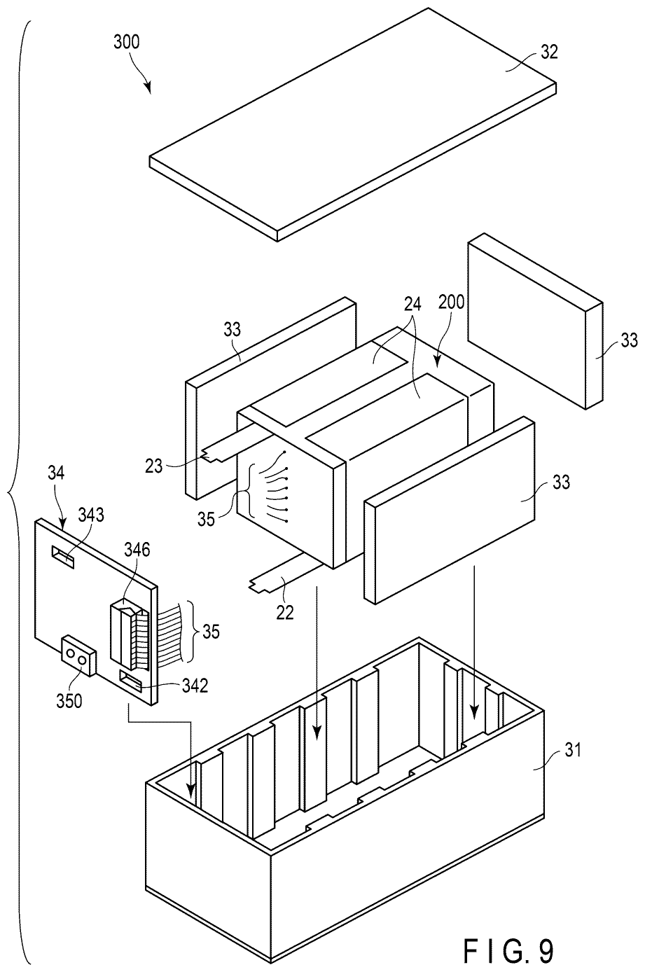

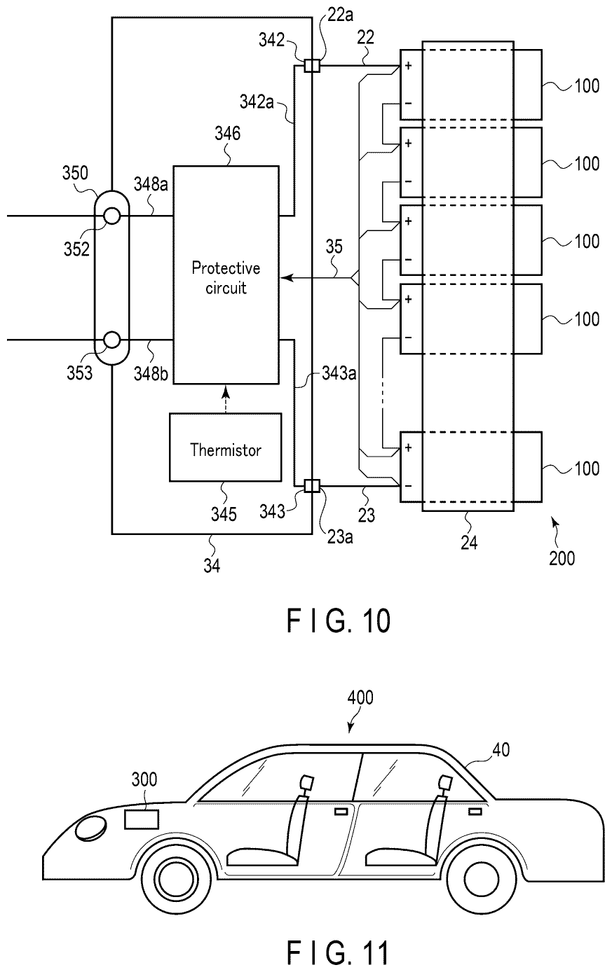

FIG. 9 is an exploded perspective view schematically showing an example of the battery pack according to the embodiment. FIG. 10 is a block diagram showing an example of an electric circuit of the battery pack shown in FIG. 9.

A battery pack 300 shown in FIGS. 9 and 10 includes a housing container 31, a lid 32, protective sheets 33, a battery module 200, a printed wiring board 34, wires 35, and an insulating plate (not shown).

A housing container 31 shown in FIG. 9 is a bottomed-square-shaped container having a rectangular bottom surface. The housing container 31 is configured to house protective sheet 33, a battery module 200, a printed wiring board 34, and wires 35. A lid 32 has a rectangular shape. The lid 32 covers the housing container 31 to house the battery module 200 and the like. Although not shown, opening(s) or connection terminal(s) for connecting to external device(s) and the like are provided on the housing container 31 and lid 32.

The battery module 200 includes plural unit cells 100, a positive electrode-side lead 22, a negative electrode-side lead 23, and an adhesive tape 24.

At least one in the plurality of unit cells 100 is a secondary battery according to the first embodiment. Each unit cell 100 in the plurality of unit cells 100 is electrically connected in series, as shown in FIG. 10. The plurality of unit cells 100 may alternatively be electrically connected in parallel, or connected in a combination of in-series connection and in-parallel connection. If the plurality of unit cells 100 is connected in parallel, the battery capacity increases as compared to a case where they are connected in series.

The adhesive tape 24 fastens the plural unit cells 100. The plural unit cells 100 may be fixed using a heat-shrinkable tape in place of the adhesive tape 24. In this case, the protective sheets 33 are arranged on both side surfaces of the battery module 200, and the heat-shrinkable tape is wound around the battery module 200 and protective sheets 33. After that, the heat-shrinkable tape is shrunk by heating to bundle the plural unit cells 100.

One terminal of a positive electrode lead 22 is connected to a battery module 200. One terminal of the positive electrode lead 22 is electrically connected to the positive electrode of one or more unit cells 100. One terminal of a negative electrode lead 23 is connected to the battery module 200. One terminal of the negative electrode lead 23 is electrically connected to the negative electrode of one or more unit cells 100.

The printed wiring board 34 is arranged on the inner surface of the housing container 31 along the short side direction. The printed wiring board 34 includes a positive electrode connector 342, a negative electrode connector 343, a thermistor 345, a protective circuit 346, wirings 342a and 343a, an external power distribution terminal 350, a plus-side wire (positive-side wire) 348a, and a minus-side wire (negative-side wire) 348b. One principal surface of the printed wiring board 34 faces one side surface of the battery module 200. An insulating plate (not shown) is disposed in between the printed wiring board 34 and the battery module 200.

The other terminal 22a of the positive electrode lead 22 is electrically connected to a positive electrode connector 342. The other terminal 23a of the negative electrode lead 23 is electrically connected to a negative electrode connector 343.

The thermistor 345 is fixed to one principal surface of the printed wiring board 34. The thermistor 345 detects the temperature of each unit cell 100 and transmits detection signals to the protective circuit 346.

The external power distribution terminal 350 is fixed to the other principal surface of the printed wiring board 34. The external power distribution terminal 350 is electrically connected to device(s) that exists outside the battery pack 300. The external power distribution terminal 350 includes a positive side terminal 352 and a negative side terminal 353.

The protective circuit 346 is fixed to the other principal surface of the printed wiring board 34. The protective circuit 346 is connected to the positive side terminal 352 via the plus-side wire 348a. The protective circuit 346 is connected to the negative side terminal 353 via the minus-side wire 348b. In addition, the protective circuit 346 is electrically connected to the positive electrode connector 342 via the wiring 342a. The protective circuit 346 is electrically connected to the negative electrode connector 343 via the wiring 343a. Furthermore, the protective circuit 346 is electrically connected to each unit cell 100 in the plurality of unit cells 100 via the wires 35.

The protective sheets 33 are arranged on both inner surfaces of the housing container 31 along the long edge direction and on one inner surface of the housing container 31 along the short edge direction facing the printed wiring board 34 through the battery module 200. The protective sheet 33 is made of, for example, resin or rubber.

The protective circuit 346 controls charging and discharging of the plurality of unit cells 100. The protective circuit 346 is also configured to cut off electric connection between the protective circuit 346 and the external power distribution terminal 350 (the positive side terminal 352 and the negative side terminal 353) to the external devices, based on detection signals transmitted from the thermistor 345 or detection signals transmitted from each unit cell 100 or the battery module 200.

An example of the detection signal transmitted from the thermistor 345 is a signal indicating that the temperature of the unit cell(s) 100 is detected to be a predetermined temperature or more. An example of the detection signal transmitted from each unit cell 100 or the battery module 200 is a signal indicating detection of over-charge, over-discharge, and overcurrent of the unit cell(s) 100. When detecting over-charge or the like for each of the unit cells 100, the battery voltage may be detected, or a positive electrode potential or negative electrode potential may be detected. In the latter case, a lithium electrode to be used as a reference electrode may be inserted into each unit cell 100.

Note, that as the protective circuit 346, a circuit included in a device (for example, an electronic device or an automobile) that uses the battery pack 300 as a power source may be used.

As described above, the battery pack 300 includes the external power distribution terminal 350. Hence, the battery pack 300 can output current from the battery module 200 to an external device and input current from an external device to the battery module 200 via the external power distribution terminal 350. In other words, when using the battery pack 300 as a power source, the current from the battery module 200 is supplied to an external device via the external power distribution terminal 350. When charging the battery pack 300, a charge current from an external device is supplied to the battery pack 300 via the external power distribution terminal 350. If the battery pack 300 is used as an onboard battery, the regenerative energy of the motive force of a vehicle can be used as the charge current from the external device.

Note that the battery pack 300 may include a plurality of battery modules 200. In this case, the plurality of battery modules 200 may be connected in series, in parallel, or connected in a combination of in-series connection and in-parallel connection. The printed wiring board 34 and the wires 35 may be omitted. In this case, the positive electrode lead 22 and the negative electrode lead 23 may be used as the positive side terminal and the negative side terminal of the external power distribution terminal, respectively.

Such a battery pack is used for, for example, an application required to have the excellent cycle performance when a large current is taken out. More specifically, the battery pack is used as, for example, a power source for electronic devices, a stationary battery, or an onboard battery for various kinds of vehicles. An example of the electronic device is a digital camera. The battery pack is particularly favorably used as an onboard battery.

A battery pack according to a third embodiment includes the secondary battery according to the first embodiment or the battery module according to the second embodiment. Therefore, the charge-discharge cycle performance can be improved.

### Fourth Embodiment

According to the fourth embodiment, a vehicle is provided. The vehicle includes the battery pack according to the third embodiment.

In a vehicle according to the fourth embodiment, the battery pack is configured, for example, to recover regenerative energy from motive force of the vehicle. The vehicle may include a mechanism configured to convert kinetic energy of the vehicle into regenerative energy.

Examples of the vehicle according to the fourth embodiment include two- to four-wheeled hybrid electric automobiles, two- to four-wheeled electric automobiles, electric assist bicycles, and railway cars.

In the vehicle according to the fourth embodiment, the installing position of the battery pack is not particularly limited. For example, the battery pack may be installed in the engine compartment of the vehicle, in rear parts of the vehicle, or under seats.

A plurality of battery packs is loaded on the vehicle according to the fourth embodiment. In this case, the batteries included in each of the battery packs may be electrically connected to each other in series, in parallel, or in a combination of in-series connection and in-parallel connection. For example, in the case where each battery pack includes a battery module, the battery modules may be electrically connected to each other in series, in parallel, or in a combination of in-series connection and in-parallel connection. Alternatively, in the case where each battery pack includes a single battery, each of the batteries may be electrically connected to each other in series, in parallel, or in a combination of in-series connection and in-parallel connection.

Next, one example of the vehicle according to the fourth embodiment will be described with reference to the drawings.

FIG. 11 is a partially transparent diagram schematically illustrating one example of a vehicle according to the embodiment.

A vehicle 400 illustrated in FIG. 11 includes a vehicle body 40 and a battery pack 300 according to the embodiment. In the example illustrated in FIG. 11, the vehicle 400 is a four-wheeled automobile.

A plurality of the battery packs 300 may be loaded on the vehicle 400. In this case, the batteries included in the battery packs 300 (for example, unit cell or battery modules) may be connected in series, connected in parallel, or connected in a combination of in-series connection and in-parallel connection.

In FIG. 11, the battery pack 300 is installed in an engine compartment located at the front of the vehicle body 40. As described above, the battery pack 300 may be installed in rear sections of the vehicle body 40, or under a seat. The battery pack 300 may be used as a power source of the vehicle 400. In addition, the battery pack 300 can recover regenerative energy of a motive force of the vehicle 400.

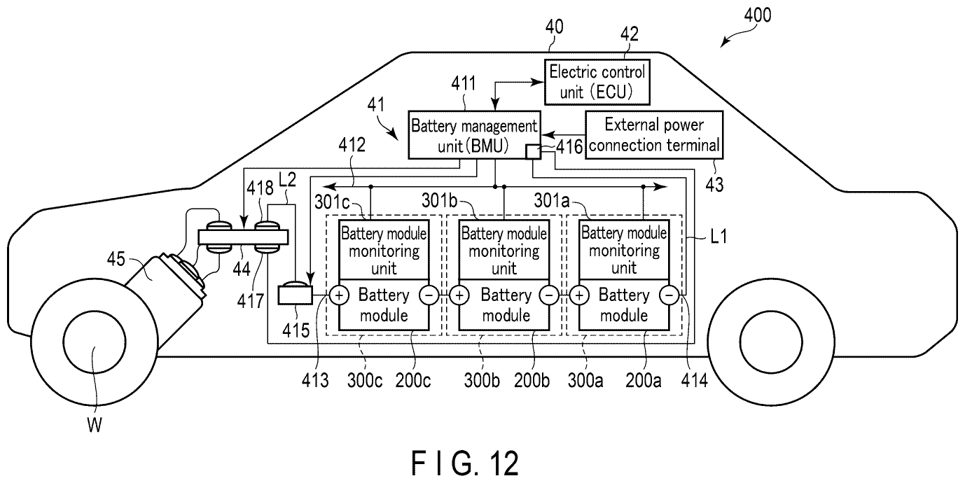

Next, an embodiment of the vehicle according to the fourth embodiment will be described with reference to FIG. 12.

FIG. 12 is a diagram schematically illustrating one example of a control system related to an electrical system in the vehicle according to the fourth embodiment. The vehicle 400 illustrated in FIG. 12 is an electric automobile.

The vehicle 400, shown in FIG. 12, includes a vehicle body 40, a vehicle power source 41, a vehicle ECU (electrical control unit) 42, which is a master controller of the vehicle power source 41, an external power connection terminal (an external terminal) 43, an inverter 44, and a drive motor 45.

The vehicle 400 includes the vehicle power source 41, for example, in the engine compartment, in the rear sections of the automobile body, or under a seat. In FIG. 12, the position of the vehicle power source 41 installed in the vehicle 400 is schematically shown.

The vehicle power source 41 includes plural (for example, three) battery packs 300a, 300b and 300c, a battery management unit (BMU) 411, and a communication bus 412.

A battery pack 300a is provided with a battery module 200a and a battery module monitoring unit 301a (for example, voltage temperature monitoring (VTM)). A battery pack 300b is provided with a battery module 200b and a battery module monitoring unit 301b. A battery pack 300c is provided with a battery module 200c and a battery module monitoring unit 301c. The battery packs 300a to 300c are battery packs similar to the battery pack 300 described earlier, and the battery modules 200a to 200c are battery modules similar to the battery module 200 described earlier. The battery modules 200a to 200c are electrically connected in series. The battery packs 300a, 300b, and 300c are removable independently of each other, and each can be replaced with a different battery pack 300.

Each of the battery modules 200a to 200c includes plural battery cells connected in series. At least one of the plural battery cells is the secondary battery according to the first embodiment. The battery modules 200a to 200c each perform charging and discharging via a positive electrode terminal 413 and a negative electrode terminal 414.

A battery management apparatus 411 communicates with the battery module monitoring unit 301a to 301c, and collects information related to the voltage, temperature, and the like for each of the unit cells 100 included in the battery modules 200a to 200c included in the vehicle power source 41. With this arrangement, the battery management apparatus 411 collects information related to the maintenance of the vehicle power source 41.

The battery management apparatus 411 and the battery module monitoring unit 301a to 301c are connected via a communication bus 412. In the communication bus 412, a set of communication wires are shared with a plurality of nodes (the battery management apparatus 411 and one or more of the battery module monitoring unit 301a to 301c). The communication bus 412 is a communication bus, for example, configured in accordance with the controller area network (CAN) standard.

The battery module monitoring units 301a to 301c measure a voltage and a temperature of each battery cell in the battery modules 200a to 200c based on commands from the battery management unit 411. It is possible, however, to measure the temperatures only at several points per battery module, and the temperatures of all of the battery cells need not be measured.

The vehicle power source 41 can also have an electromagnetic contactor (for example, a switch apparatus 415 illustrated in FIG. 12) that switches the presence or absence of an electrical connection between a positive electrode terminal 413 and a negative electrode terminal 414. The switch apparatus 415 includes a pre-charge switch (not illustrated) that turns on when the battery modules 200a to 200c are charged, and a main switch (not illustrated) that turns on when the output from the battery modules 200a to 200c is supplied to the load. Each of the pre-charge switch and the main switch is provided with a relay circuit (not illustrated) that switches on or off according to a signal supplied to a coil disposed near a switching element. The electromagnetic contactor such as the switch apparatus 415 is controlled according to of control signals from the battery management apparatus 411 or the vehicle ECU 42 that controls the entire operation of the vehicle 400.

The inverter 44 converts an inputted direct current voltage to a three-phase alternate current (AC) high voltage for driving a motor. Three-phase output terminal(s) of the inverter 44 is (are) connected to each three-phase input terminal of the drive motor 45. The inverter 44 is controlled based on control signals from the battery management apparatus 411, or the vehicle ECU 42 which controls the entire operation of the vehicle. By controlling the inverter 44, the output voltage from the inverter 44 is adjusted.

The drive motor 45 is rotated by electric power supplied from the inverter 44. The driving force produced by the rotation of the drive motor 45 is transmitted to an axle (or axles) and drive wheels W via a differential gear unit for example.

The vehicle 400 also includes a regenerative brake mechanism (regenerator), though not shown. The regenerative brake mechanism rotates the drive motor 45 when the vehicle 400 is braked, and converts kinetic energy into regenerative energy, as electric energy. The regenerative energy, recovered in the regenerative brake mechanism, is inputted into the inverter 44 and converted to direct current. The converted direct current is inputted into the vehicle power source 41.

One terminal of a connection line Li is connected to the negative electrode terminal 414 of the vehicle power source 41. The other terminal of the connection line Li is connected to a negative electrode input terminal 417 of the inverter 44. On the connection line Li, a current detector (current detection circuit) 416 is provided inside the battery management apparatus 411 between the negative electrode terminal 414 and the negative electrode input terminal 417.

One terminal of a connection line L2 is connected to the positive electrode terminal 413 of the vehicle power source 41. The other terminal of the connection line L2 is connected to a positive electrode input terminal 418 of the inverter 44. On the connection line L2, the switch apparatus 415 is provided between the positive electrode terminal 413 and the positive electrode input terminal 418.

The external terminal 43 is connected to the battery management apparatus 411. The external terminal 43 can be connected to, for example, an external power source.

The vehicle ECU 42 cooperatively controls the vehicle power source 41, the switch apparatus 415, the inverter 44, and the like together with other management apparatus and control apparatus, including the battery management apparatus 411, in response to operation input from a driver or the like. By the cooperative control by the vehicle ECU 42 and the like, the output of electric power from the vehicle power source 41, the charging of the vehicle power source 41, and the like are controlled, and the vehicle 400 is managed as a whole. Data related to the maintenance of the vehicle power source 41, such as the remaining capacity of the vehicle power source 41, is transferred between the battery management apparatus 411 and the vehicle ECU 42 by a communication line.

A vehicle according to a fourth embodiment is equipped with the battery pack according to the third embodiment. Since the charge-discharge cycle performance of the battery pack is high, the reliability of the vehicle can be improved.

### EXAMPLES

Examples will be described below, but the embodiments are not limited to the examples described below.

### Example 1

### (Production of Negative Electrode)

As a negative electrode current collector, an aluminum foil with a thickness of 15 μm was prepared.

A slurry in which TiNb₂O₇ as a negative electrode active material, acetylene black as an electro-conductive agent, and carboxymethyl cellulose and styrene butadiene rubber as a binder were dispersed in a solvent was applied to the negative electrode current collector to form a negative electrode active material-containing layer. At this time, the ratios of the negative electrode active material, the electro-conductive agent, the carboxymethyl cellulose, and the styrene butadiene rubber in the negative electrode active material-containing layer were set to 100 parts by mass, 4 parts by mass, 1 part by mass and 2 parts by mass, respectively. The application amount of the negative electrode active material-containing layer was 100 g/m², and the density was 2.5 g/cm³. The negative electrode active material-containing layer was formed in a band shape having a pair of long edges and a pair of short edges. The negative electrode active material-containing layer was not provided on a portion of the negative electrode current collector. This portion was used as a negative electrode tab.

Negative electrodes were produced as described above. As the negative electrodes, two kinds of negative electrodes were produced: a negative electrode S and a negative electrode L in which the long edges of the negative electrode active material-containing layer were longer than those of the negative electrode S. Prepared in Example 1 were eight negative electrodes in which the area of the negative electrode active material-containing layer (long edge length×short edge length) was 200.0 mm×95.0 mm as the negative electrodes S, and eight negative electrodes in which the area of the negative electrode active material-containing layer was 201.5 mm×95.0 mm as the negative electrodes L.

### (Production of Positive Electrode)

An aluminum foil with a thickness of 15 μm was prepared.

A slurry in which LiNi_{0.8}Co_{0.1}Mn_{0.1}O₂ as a positive electrode active material, acetylene black as an electro-conductive agent, and PVdF as a binder were dispersed in a solvent was applied to the positive electrode current collector to form a positive electrode active material-containing layer. At this time, the ratios of the positive electrode active material, the electro-conductive agent, and the binder in the positive electrode active material-containing layer were set to 100 parts by mass, 3 parts by mass, and 2 parts by mass, respectively. The application amount of the positive electrode active material-containing layer was 115 g/m², and the density was 3.3 g/cm³. The positive electrode active material-containing layer was formed in a band shape having a pair of long edges and a pair of short edges. The positive electrode active material-containing layer was not provided on a portion of the positive electrode current collector. This portion was used as a positive electrode tab. The area of the positive electrode active material-containing layer (length of long edge×length of short edge) was set to 195.0 mm×90.0 mm.

### (Assembly of Battery)

As a separator, a polyethylene film with a thickness of 15 μm and a width of 208.0 mm was prepared. The separator was folded in a zigzag manner by alternately repeating mountain folds and valley folds. At this time, the separator was folded with each folding line along the width direction. The negative electrodes and the positive electrodes were alternately arranged in spaces in the separator folded in a zigzag. Of the negative electrodes, the negative electrodes S and the negative electrodes L were randomly arranged. At the time of stacking, the positive electrode tabs and the negative electrode tabs were arranged so as to extend in opposite directions.

That is, a direction in which the negative electrode tabs extend with respect to the negative electrode current collector was defined as a first direction, and the positive electrode tabs were arranged so as to extend in a second direction opposite to the first direction. An end of each negative electrode positioned at an end in the second direction was defined as a second negative electrode end. In addition, an end of the negative electrode active material-containing layer positioned at an end in the first direction was defined as a first negative electrode end. An end of each positive electrode positioned at an end in the first direction was defined as a first positive electrode end. In addition, an end of the positive electrode active material-containing layer positioned at an end in the second direction was defined as a second positive electrode end. In the separator, an end positioned at an end in the first direction was defined as a first separator end, and an end positioned at an end in the second direction was defined as a second separator end.

The negative electrodes and the positive electrodes were stacked as described below.

The negative electrode S was arranged such that the distance between the first negative electrode end of the negative electrode S and the first separator end was equal to the distance between the second negative electrode end and the second separator end. That is, the first separator end was arranged so as to protrude by 4.0 mm beyond the first negative electrode end of the negative electrode S, and the second separator end was arranged so as to protrude by 4.0 mm beyond the second negative electrode end of the negative electrode S.

The negative electrode L was arranged such that the first negative electrode end of the negative electrode L and the first negative electrode end of the negative electrode S overlapped each other along the thickness direction. In other words, all the negative electrodes were stacked such that the first negative electrode ends were aligned. That is, the first separator end was arranged so as to protrude by 4.0 mm beyond the first negative electrode end of the negative electrode L, and the second separator end was arranged so as to protrude by 2.5 mm beyond the second negative electrode end of the negative electrode L.

The positive electrode was arranged such that the distance between the first positive electrode end and the first negative electrode end of the negative electrode S was equal to the distance between the second positive electrode end and the second negative electrode end of the negative electrode S. That is, the first negative electrode end of the negative electrode S was arranged so as to protrude by 2.5 mm beyond the first positive electrode end, and the second negative electrode end of the negative electrode S was arranged so as to protrude by 2.5 mm beyond the second positive electrode end. The layers were stacked such that the distance between the first positive electrode end and the first separator end was 6.5 mm for each positive electrode.

As described above, the positive electrodes, the negative electrodes, and the separators were stacked to obtain an electrode group.

A tab of aluminum was ultrasonically welded to each of the positive electrode current collector and the negative electrode current collector included in the obtained electrode group. Thereafter, the electrode group was stored in a pack made of a laminate film as a container member, and then vacuum-dried at 80 °C for 12 hours. Thereafter, in a glove box under an argon atmosphere, a liquid nonaqueous electrolyte was injected into the pack made of a laminate film, and completely sealed by heat sealing to produce a battery. The liquid nonaqueous electrolyte was obtained by dissolving LiPF₆ at a concentration of 1M in a solvent obtained by mixing PC and MEC at a volume ratio of 1:2.

The obtained battery was initially charged and discharged under the following conditions. The charging was performed in a constant current and constant voltage mode in a thermostatic bath under an environment of 25 °C. The battery was charged at 0.2 C up to 2.95 V, and after reaching 2.95 V, was charged under constant voltage until the current reached 0.05 C. After resting for 10 minutes, the battery was discharged in a constant current mode. The discharging was performed at 0.2 C until the voltage reached 1.5 V. At the time of initial charge and discharge, the battery was restrained by bringing a bakelite plate into contact with both surfaces of the battery and further sandwiching the battery with a pair of aluminum plates from the outside. At this time, the surface pressure was adjusted to 0.1 MPa. Thus, a secondary battery was produced.

### Example 2

In the production of the negative electrodes, the area of the negative electrode active material-containing layer of the negative electrode L was changed to 202.0 mm×95.0 mm. In the stacking, the second separator end was arranged so as to protrude 2.0 mm beyond the second negative electrode end of the negative electrode L. A secondary battery was produced in the same manner as in Example 1 except for the above.

### Example 3

In the production of the negative electrodes, the area of the negative electrode active material-containing layer of the negative electrode S was changed to 198.0 mm×95.0 mm, and the area of the negative electrode active material-containing layer of the negative electrode L was changed to 199.0 mm×95.0 mm.

In the stacking, the negative electrode S was arranged such that the first separator end protruded by 5.0 mm beyond the first negative electrode end of the negative electrode S and the second separator end protruded by 5.0 mm beyond the second negative electrode end of the negative electrode S. The negative electrode L was arranged such that the first separator end protruded by 5.0 mm beyond the first negative electrode end of the negative electrode L, and the second separator end protruded by 4.0 mm beyond the second negative electrode end of the negative electrode L. A secondary battery was produced in the same manner as in Example 1 except for the above.

### Example 4

In the production of the negative electrodes, the area of the negative electrode active material-containing layer of the negative electrode S was changed to 198.0 mm×95.0 mm, and the area of the negative electrode active material-containing layer of the negative electrode L was changed to 201.0 mm×95.0 mm.

In the stacking, the negative electrode S was arranged such that the first separator end protruded by 5.0 mm beyond the first negative electrode end of the negative electrode S and the second separator end protruded by 5.0 mm beyond the second negative electrode end of the negative electrode S. The negative electrode L was arranged such that the first separator end protruded by 5.0 mm beyond the first negative electrode end of the negative electrode L, and the second separator end protruded by 2.0 mm beyond the second negative electrode end of the negative electrode L. A secondary battery was produced in the same manner as in Example 1 except for the above.

### Example 5

In the production of the negative electrodes, the area of the negative electrode active material-containing layer of the negative electrode S was changed to 201.0 mm×95.0 mm, and the area of the negative electrode active material-containing layer of the negative electrode L was changed to 202.0 mm×95.0 mm.

In the production of the positive electrodes, the area of the positive electrode active material-containing layer of each positive electrode was changed to 200.0 mm×90.0 mm.

In the stacking, the negative electrode S was arranged such that the first separator end protruded by 3.5 mm beyond the first negative electrode end of the negative electrode S and the second separator end protruded by 3.5 mm beyond the second negative electrode end of the negative electrode S. The first separator end was arranged so as to protrude by 3.5 mm beyond the first negative electrode end of the negative electrode L.

The first negative electrode end of the negative electrode S was arranged so as to protrude by 0.5 mm beyond the first positive electrode end, and the second negative electrode end of the negative electrode S was arranged so as to protrude by 0.5 mm beyond the second positive electrode end. The layers were stacked such that the distance between the first positive electrode end and the first separator end was 4.0 mm for each positive electrode. A secondary battery was produced in the same manner as in Example 1 except for the above.

### Example 6

A secondary battery was produced in the same manner as in Example 1 except that the type of the negative electrode active material was changed to Nb₁₆W₅O₅₅.

### Example 7

### (Production of Negative Electrode)

As a negative electrode current collector, an aluminum foil with a thickness of 15 μm was prepared.

A slurry in which hard carbon as a negative electrode active material, acetylene black as an electro-conductive agent, and carboxymethyl cellulose and styrene butadiene rubber as a binder, were dispersed in a solvent was applied to the negative electrode current collector to form a negative electrode active material-containing layer. At this time, the ratios of the negative electrode active material, the electro-conductive agent, the carboxymethyl cellulose, and the styrene butadiene rubber in the negative electrode active material-containing layer were set to 100 parts by mass, 4 parts by mass, 1 part by mass and 2 parts by mass, respectively. The application amount of the negative electrode active material-containing layer was 100 g/m², and the density was 2.5 g/cm³.

The negative electrode active material-containing layer was not provided on a portion of the negative electrode current collector. This portion was used as a negative electrode tab.

Negative electrodes were produced as described above. Two types of negative electrodes, a negative electrode (negative electrode S) having a coated portion with an area of 200.0 mm×95.0 mm and a negative electrode (negative electrode L) having a coated portion with an area of 202.0 mm×95.0 mm, were prepared in 8 sheets each.

### (Production of Positive Electrode)

An aluminum foil with a thickness of 15 μm was prepared.

A slurry in which NaFe_{0.33}Ni_{0.33}Mn_{0.33}O₂ as a positive electrode active material, acetylene black as an electro-conductive agent, and PVdF as a binder were dispersed in a solvent was applied to the positive electrode current collector to form a positive electrode active material-containing layer. At this time, the ratios of the positive electrode active material, the electro-conductive agent, and the binder in the positive electrode active material-containing layer were set to 100 parts by mass, 3 parts by mass, and 2 parts by mass, respectively. The application amount of the positive electrode active material-containing layer was 125 g/m², and the density was 2.9 g/cm³.

The positive electrode active material-containing layer was not provided on a portion of the positive electrode current collector. This portion was used as a positive electrode tab. The area of the applied part was set to 195.0 mm×90.0 mm.

### (Assembly of Battery)

A tab of aluminum was ultrasonically welded to each of the positive electrode current collector and the negative electrode current collector included in the obtained electrode group. The liquid nonaqueous electrolyte was obtained by dissolving NaPF₆ at a concentration of 1M in a solvent obtained by mixing PC and MEC at a volume ratio of 1:2.

A battery was produced in the same manner as in Example 1 except for the above. The secondary battery according to Example 7 was a sodium secondary battery.

### Examples 8 to 11

A secondary battery was produced in the same manner as in Example 1 except that the thickness of the current collector was as described in Table 1.

### Comparative Example 1

In the production of the negative electrodes, the area of the negative electrode active material-containing layer of the negative electrode S was changed to 201.0 mm×95.0 mm, and the area of the negative electrode active material-containing layer of the negative electrode L was changed to 203.0 mm×95.0 mm.

In the stacking, the negative electrode S was arranged such that the first separator end protruded by 3.5 mm beyond the first negative electrode end of the negative electrode S and the second separator end protruded by 3.5 mm beyond the second negative electrode end of the negative electrode S. The negative electrode L was arranged such that the first separator end protruded by 3.5 mm beyond the first negative electrode end of the negative electrode L, and the second separator end protruded by 1.5 mm beyond the second negative electrode end of the negative electrode L. Further, the surface pressure at the time of restraint in the initial charge and discharge was adjusted to 0.3 MPa. A secondary battery was produced in the same manner as in Example 1 except for the above.

### Comparative Example 2

In the production of the negative electrodes, the area of the negative electrode active material-containing layer of the negative electrode S was changed to 201.0 mm×95.0 mm, and the area of the negative electrode active material-containing layer of the negative electrode L was changed to 203.0 mm×95.0 mm.

In the stacking, the negative electrode S was arranged such that the first separator end protruded by 3.5 mm beyond the first negative electrode end of the negative electrode S and the second separator end protruded by 3.5 mm beyond the second negative electrode end of the negative electrode S. The negative electrode L was arranged such that the first separator end protruded by 3.5 mm beyond the first negative electrode end of the negative electrode L, and the second separator end protruded by 1.5 mm beyond the second negative electrode end of the negative electrode L. A secondary battery was produced in the same manner as in Example 7 except for the above.

### (Measurement)

Initial charge and discharge was performed for the secondary batteries of Examples and Comparative Examples. Thereafter, the secondary batteries were completely discharged, and Lnₘᵢₙ, Lnₘₐₓ, and Lpₘᵢₙ were measured by the method described above. In addition, the difference between Lnₘₐₓ and Lnₘᵢₙ and the difference between Lpₘᵢₙ and Lnₘᵢₙ were calculated. Further, the type of the negative electrode active material and the thickness of the current collector were identified by the method described above. Table 1 shows the above measurement results.

### (Evaluation)

For the batteries of Examples and Comparative Examples, a 500-cycle capacity retention ratio was measured as described below.

The battery to be measured was charged at 2C and then discharged at 2C, at 25 °C. Charging and discharging were repeated 500 times with this charging and discharging as one cycle. The discharge capacity was measured at the time of discharge at the 1st cycle and the 500th cycle. The discharge capacity at the 500th cycle was divided by the discharge capacity at the 1st cycle and multiplied by 100 to obtain the 500-cycle capacity retention ratio (%). The 500-cycle capacity retention ratio is an index of charge-discharge cycle performance.

| | | | Difference | | Difference | Type of | | 500-cycle |
|---|---|---|---|---|---|---|---|---|
| | | | between | | between | negative | Thickness | capacity |
| | | | Lnₘₐₓ and | | Lpₘᵢₙ and | electrode | of current | retention |
| | Lnₘᵢₙ | Lnₘₐₓ | Lnₘᵢₙ | Lpₘᵢₙ | Lnₘᵢₙ | active | collector | ratio |
| | (mm) | (mm) | (mm) | (mm) | (mm) | material | (μm) | (%) |
| Example 1 | 2.0 | 3.5 | 1.5 | 6.5 | 4.5 | TiNb₂O₇ | 15 | 91 |
| Example 2 | 1.5 | 3.5 | 2.0 | 6.5 | 5.0 | TiNb₂O₇ | 15 | 89 |
| Example 3 | 3.5 | 4.5 | 1.0 | 6.5 | 3.0 | TiNb₂O₇ | 15 | 94 |
| Example 4 | 1.5 | 4.5 | 2.5 | 6.5 | 5.0 | TiNb₂O₇ | 15 | 90 |
| Example 5 | 2.0 | 3.0 | 1.0 | 3.5 | 1.5 | TiNb₂O₇ | 15 | 90 |
| Example 6 | 2.0 | 3.5 | 1.5 | 6.5 | 4.5 | Nb₁₆W₅O₅₅ | 15 | 88 |
| Example 7 | 2.0 | 3.5 | 1.5 | 6.5 | 4.5 | Hard carbon | 15 | 89 |
| Example 8 | 2.0 | 3.5 | 1.5 | 6.5 | 4.5 | TiNb₂O₇ | 7 | 90 |
| Example 9 | 2.0 | 3.5 | 1.5 | 6.5 | 4.5 | TiNb₂O₇ | 20 | 93 |
| Example 10 | 2.0 | 3.5 | 1.5 | 6.5 | 4.5 | TiNb₂O₇ | 6 | 89 |
| Example 11 | 2.0 | 3.5 | 1.5 | 6.5 | 4.5 | TiNb₂O₇ | 25 | 93 |
| Comparative | 1.0 | 3.0 | 2.0 | 6.5 | 5.5 | TiNb₂O₇ | 15 | 82 |
| Example 1 | | | | | | | | |
| Comparative | 1.0 | 3.0 | 2.0 | 6.5 | 5.5 | Hard carbon | 15 | 80 |
| Example 2 | | | | | | | | |

In all the secondary batteries of Examples 1 to 11, the minimum value Lnₘᵢₙ of the distances Ln between the second negative electrode ends of the negative electrodes and the second separator end was 1.5 mm or more, and the difference between the maximum value Lnₘₐₓ and Lnₘᵢₙ of Ln was 1.0 mm or more. Therefore, Examples 1 to 11 were all higher in 500-cycle capacity retention ratio than the secondary batteries of Comparative Examples 1 and 2. That is, the charge-discharge cycle performance was good.

In the secondary batteries of Examples and Comparative Examples, the measured values of the distance between each electrode end and the separator end shown in Table 1 were different from the values at the time of assembly. Specifically, Lnₘᵢₙ, Lnₘₐₓ, and the difference between Lpₘᵢₙ and Lnₘᵢₙ were different. This is considered to be due to slight expansion and contraction of the negative electrodes included in the electrode group due to the initial charge and discharge of the secondary battery.

In Comparative Examples 1 and 2, the value of Lnₘᵢₙ was as small as 1.0 mm. Therefore, it is considered that a short circuit is likely to occur because the distance between the second negative electrode end and the second separator end is too small, and thus charging is difficult. As a result, it is considered that the 500-cycle capacity retention rate was low.

From the results of Examples 1 to 3, it has become clear that the effect of improving the charge-discharge cycle performance can be obtained even if the value of Lnₘᵢₙ is changed. In addition, in Example 3 in which the value of Lnₘᵢₙ was large, the charge-discharge cycle performance was particularly good. This is considered to be because a sufficient distance between the second negative electrode end and the second separator end was secured in all the negative electrodes, so that the occurrence of a short circuit was effectively suppressed.

From the results of Examples 1 and 4, it has become clear that excellent charge-discharge cycle performance can be obtained even if the difference between Lnₘₐₓ and Lnₘᵢₙ is changed. Further, from the results of Examples 1 and 5, it has become clear that excellent charge-discharge cycle performance can be obtained even if Lpₘᵢₙ and the difference between Lpₘᵢₙ and Lnₘᵢₙ are changed.

From the results of Examples 1, 6, and 7, it has become clear that excellent charge-discharge cycle performance can be obtained even if the type of the negative electrode active material is changed. From the results of Example 7, it has become clear that excellent charge-discharge cycle performance can be obtained even if the secondary battery is a sodium secondary battery.

From the results of Examples 1 and 8 to 11, it has become clear that excellent charge-discharge cycle performance can be obtained even if the thickness of the negative electrode current collector is variously changed. In particular, since the electrode strength can be improved as the negative electrode current collector is thicker, the charge-discharge cycle performance tended to be excellent. However, from the viewpoint of the capacity density of the battery, Examples 1 and 9 in which the current collector was thin were superior to Example 11.

According to at least one embodiment or example described above, a secondary battery is provided. The secondary battery includes positive electrodes, negative electrodes, and a separator interposed between the positive electrodes and the negative electrodes. Each of the negative electrodes includes a negative electrode current collector, a negative electrode tab, and a negative electrode active material-containing layer provided at the negative electrode current collector. The negative electrode current collector contains aluminum or an aluminum alloy. The negative electrode tab is electrically connected to the negative electrode current collector and extends along a first direction. Each of the negative electrode has a second negative electrode end positioned at an end in a second direction opposite to the first direction. The separator has a first separator end positioned at an end in the first direction and a second separator end positioned at an end in the second direction. The second separator end protrudes in the second direction beyond the second negative electrode end of the negative electrodes. Lnₘᵢₙ is 1.5 mm or more. The difference between the Lnₘᵢₙ and Lnₘₐₓ is 1.0 mm or more. The Lnₘᵢₙ denotes a minimum value of Ln which is a distance between the second negative electrode end and the second separator end. The Lnₘₐₓ denotes a maximum value of the Ln. Therefore, the secondary battery can improve charge-discharge cycle performance.

Hereinafter, the invention according to the embodiments will be additionally described.
<1> A secondary battery comprising:
positive electrodes; negative electrodes; and a separator interposed between the positive electrodes and the negative electrodes, wherein
each of the negative electrodes includes:
a negative electrode current collector containing aluminum or an aluminum alloy;
a negative electrode tab electrically connected to the negative electrode current collector and extending along a first direction;
a negative electrode active material-containing layer provided at the negative electrode current collector; and
a second negative electrode end positioned at an end in a second direction opposite to the first direction,
the separator has a first separator end positioned at an end in the first direction and a second separator end positioned at an end in the second direction,
the second separator end protrudes in the second direction beyond the second negative electrode end of the negative electrodes,
Lnₘᵢₙ is 1.5 mm or more, and
a difference between the Lnₘᵢₙ and Lnₘₐₓ is 1.0 mm or more,
where the Lnₘᵢₙ denotes a minimum value of Ln which is a distance between the second negative electrode end and the second separator end, and the Lnₘₐₓ denotes a maximum value of the Ln.
<2> The secondary battery according to <1>, wherein
each of the negative electrodes includes a first negative electrode end positioned at an end of the negative electrode active material-containing layer of each of the negative electrodes in the first direction,
each of the positive electrode includes:
a positive electrode current collector;
a positive electrode tab electrically connected to the positive electrode current collector and extending along the second direction;
a positive electrode active material-containing layer provided at the positive electrode current collector;
a first positive electrode end positioned at an end in the first direction; and
a second positive electrode end positioned at an end in the second direction,
the first negative electrode end of the negative electrodes protrude in the first direction beyond the first positive electrode end of the positive electrodes,
the second negative electrode end of the negative electrodes protrude in the second direction beyond the second positive electrode end of the positive electrodes, and
a difference between Lpₘᵢₙ and Lnₘᵢₙ is 1.5 mm or more,
where the Lpₘᵢₙ denotes a minimum value of Lp which is a distance between the second positive electrode end and the second separator end.
<3> The secondary battery according to <1> or <2>, wherein the secondary battery is a lithium ion secondary battery.
<4> The secondary battery according to any one of <1> to <3>, wherein the negative electrode active material-containing layer contains a niobium titanium-containing oxide.
<5> The secondary battery according to any one of <1> to <4>, wherein the negative electrode active material-containing layer contains hard carbon.
<6> The secondary battery according to any one of <1> to <5>, wherein the negative electrode current collector has a thickness of 7 μm or more and 20 μm or less.
<7> The secondary battery according to any one of <1> to <6>, comprising a plurality of the separator.
<8> The secondary battery according to any one of <1> to <7>, wherein the separator is folded in a zigzag.
<9> A battery pack comprising the secondary battery according to any one of <1> to <8>.
<10> The battery pack according to <9>, further comprising:
an external power distribution terminal; and
a protective circuit.
<11> The battery pack according to <9>, comprising a plurality of the secondary battery, wherein
the plurality of secondary batteries are electrically connected in series, in parallel, or in a combination of series connection and parallel connection.
<12> A vehicle comprising the battery pack according to <9>.
<13> The vehicle according to <12>, further comprising a mechanism configured to convert kinetic energy of the vehicle into regenerative energy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A secondary battery comprising:
positive electrodes; negative electrodes; and a separator interposed between the positive electrodes and the negative electrodes, wherein
each of the negative electrodes includes:
a negative electrode current collector containing aluminum or an aluminum alloy;
a negative electrode tab electrically connected to the negative electrode current collector and extending along a first direction;
a negative electrode active material-containing layer provided at the negative electrode current collector; and
a second negative electrode end positioned at an end in a second direction opposite to the first direction,
the separator has a first separator end positioned at an end in the first direction and a second separator end positioned at an end in the second direction,
the second separator end protrudes in the second direction beyond the second negative electrode end of the negative electrodes,
Lnₘᵢₙ is 1.5 mm or more, and
a difference between the Lnₘᵢₙ and Lnₘₐₓ is 1.0 mm or more,
where the Lnₘᵢₙ denotes a minimum value of Ln which is a distance between the second negative electrode end and the second separator end, and the Lnₘₐₓ denotes a maximum value of the Ln.

2. The secondary battery according to claim 1, wherein
each of the negative electrodes includes a first negative electrode end positioned at an end of the negative electrode active material-containing layer of each of the negative electrodes in the first direction,
each of the positive electrode includes:
a positive electrode current collector;
a positive electrode tab electrically connected to the positive electrode current collector and extending along the second direction;
a positive electrode active material-containing layer provided at the positive electrode current collector;
a first positive electrode end positioned at an end in the first direction; and
a second positive electrode end positioned at an end in the second direction,
the first negative electrode end of the negative electrodes protrude in the first direction beyond the first positive electrode end of the positive electrodes,
the second negative electrode end of the negative electrodes protrude in the second direction beyond the second positive electrode end of the positive electrodes, and
a difference between Lpₘᵢₙ and Lnₘᵢₙ is 1.5 mm or more,
where the Lpₘᵢₙ denotes a minimum value of Lp which is a distance between the second positive electrode end and the second separator end.

3. The secondary battery according to claim 1, wherein the secondary battery is a lithium ion secondary battery.

4. The secondary battery according to claim 1, wherein the negative electrode active material-containing layer contains a niobium titanium-containing oxide.

5. The secondary battery according to claim 1, wherein the negative electrode active material-containing layer contains hard carbon.

6. The secondary battery according to claim 1, wherein the negative electrode current collector has a thickness of 7 μm or more and 20 μm or less.

7. The secondary battery according to claim 1, comprising a plurality of the separator.

8. The secondary battery according to claim 1, wherein the separator is folded in a zigzag.

9. A battery pack comprising the secondary battery according to claim 1.

10. The battery pack according to claim 9, further comprising:
an external power distribution terminal; and
a protective circuit.

11. The battery pack according to claim 9, comprising a plurality of the secondary battery, wherein
the plurality of secondary batteries are electrically connected in series, in parallel, or in a combination of series connection and parallel connection.

12. A vehicle comprising the battery pack according to claim 9.

13. The vehicle according to claim 12, further comprising a mechanism configured to convert kinetic energy of the vehicle into regenerative energy.
